(19) United States
(12) Patent Application Publication
(10) Pub. No.: US 2006/0235666 A1
(43) Pub. Date: Oct. 19, 2006

(54) System and method for representing and processing and modeling subterranean surfaces

(76) Inventors: Steven Brent Assa, Cambridge (GB); Christoph Ramshorn, Cambridge (GB)

Correspondence Address: SCHLUMBERGER-DOLL RESEARCH, 36 OLD QUARRY ROAD, RIDGEFIELD, CT, 06877-4108, US

(21) Appl. No.: 10/538,316

(22) PCT Filed: Dec. 11, 2003
(86) PCT No.: PCT/GB03/05395

§ 371 Date: Nov. 4, 2005

(30) Foreign Application Priority Data
Dec. 21, 2002 (GB) 0229991.5

(51) Int. Cl. G06G 7/48

(52) U.S. Cl. 703/10

(57) ABSTRACT

Methods and systems are disclosed for processing data used for hydrocarbon extraction from the earth. Symmetry transformation groups are identified from sampled earth structure data. A set of critical points is identified from the sampled data. Using the symmetry groups and the critical points, a plurality of subdivisions of shapes is generated, which together represent the original earth structures. The symmetry groups correspond to a plurality of shape families, each of which includes a set of predicted critical points. The subdivisions are preferably generated such that a shape family is selected according to a best fit between the critical points from the sampled data and the predicted critical points of the selected shape family.

### FIELD OF THE INVENTION

The present invention relates to the field of earth models for subterranean surfaces. In particular, the invention relates to systems and methods for improved representations and processing techniques for subterranean earth surfaces in earth models used in the exploration and production of hydrocarbon reservoirs.

### BACKGROUND OF THE INVENTION

In the field of processing earth model data for use in the extraction of hydrocarbons from the earth, significant resources have been invested in creating functionality and stabilizing the software quality of modeling technology. The efforts have been based on faceted representations, and in particular triangulated surface methods. However, there are number of key problems associated with extending triangulated surface methods.

1. Sampling a smooth surface discretely, for example with points arranged in a triangle mesh, is inherently inefficient. In contrast, smooth surfaces can be represented as a Taylor series or as an eigen-function expansion, e.g., Fourier series of some form. An eigen-function expansion can be used to compute an algebraic expression to evaluate normal fields, tangent fields, etc. This is inherently more compact and efficient than a 2D or 3D sampling lattice with some sort of interpolation.

2. The lack of differentiation makes calculation of a triangulated surface intersection algorithm numerically delicate.

3. Triangles can be used to define shape, but triangles do not efficiently convey an intuitive sense of shape. High resolution and high sampling density make the problem more difficult.

4. Low efficiency triangulation forces application developers to either worry about memory management or to curb flexibility of data set processing.

5. Efficient management of large models means localizing change. It is possible in principle to develop localization methods using triangulated surface models but there are numerical stability issues-seen in reference to intersection.

### SUMMARY OF THE INVENTION

Thus, it is an object of the present invention to provide an improved system and method for processing data used for hydrocarbon extraction.

Advantageously the invention allows for improved memory and CPU efficiency of implicit surface construction and editing algorithms.

According to the invention a method is provided for processing data used for hydrocarbon extraction from the earth. The method includes the following steps. Receiving sampled data representing earth structures. Identifying one more symmetry transformation groups from the sampled data. Identifying a set of critical points from the sampled data. Generating a plurality of subdivisions of shapes, the subdivisions together representing the earth structures, the generation being based at least in part on the set of identified critical points and the symmetry transformation groups. Processing earth model data using the generated subdivision of shapes. And, altering activity relating to extraction of hydrocarbons from a hydrocarbon reservoir based on the processed earth model data.

The identified symmetry transformation group is preferably a set of diffeomorphisms that act on a topologically closed and bounded region in space-time such that under transformation the region occupies the same points in space.

The identified symmetry transformation groups preferably correspond to a plurality of shape families, each of which includes a set of predicted critical points. The subdivisions are preferably generated such that a shape family is selected from the plurality of shape families that corresponds to the identified symmetry transformation group. The selection is preferably being based on closeness of correspondence between the identified critical points from the sampled data and the predicted critical points of the selected shape family.

Each shape family preferably has an associated set of symmetry transformation group orbits, with each orbit being associated with orbit information that specifies whether the orbit contains a predicted critical point and value of the Gaussian curvature of a point in the orbit. The orbit information from the set of symmetry transformation group orbits associated with the selected shape family is preferably applied to the sampled data thereby generating a unique specification of a shape from the selected shape family. Each of the plurality of subdivisions of shapes is preferably generated by identifying a part of the uniquely specified shape that corresponds to the sampled data. The identified parts are assembled, thereby generating a representation of the earth structures.

The plurality of subdivisions are preferably generated such that the number of parameters in each subdivision times the number of subdivisions is substantially less then would be needed using a faceted representation method, and the plurality of subdivisions is more numerically stable than third order or higher representation.

The invention is also embodied in a system for improved extraction of hydrocarbons from the earth, and in a computer readable medium capable of causing a computer system to carry out steps for processing data relating to earth structures for the extraction of hydrocarbons.

### BRIEF DESCRIPTION OF THE DRAWINGS

FIG. 1 shows an open surface and its embedding in a closed surface;

FIG. 2 shows a salt mass's steep flanks and overhangs;

FIG. 3 shows an example of a 4D representation of a field in Turkmanistan;

FIG. 4 is an image of the MacKenzie River Delta;

FIG. 5 shows some combinations of involved spherical harmonic polynomials, presented in spherical polar coordinates;

FIG. 6 illustrates that in most cases a surface evolves under mcf to a point;

FIGS. 7a-f forms a series of six images showing vpmcf suppressing noise;

FIG. 8 illustrates the orthogonality condition of the theorem proposed by Athanassenas;

FIG. 9 is an aerial image of part of Big Bend National Park, showing the approximation of a plateau to a characteristic length scale cone;

FIG. 10 is a side view of a noise cone structure;

FIG. 11 is a satellite image of the Labrador Trough;

FIG. 12 shows s a sequence of folded sediment on the coast of the Gulf of Oman;

FIG. 13 is an image illustrating progressive flattening of an overburden covering a large salt intrusion;

FIG. 14 is a diagram illustrating the Morse theoretical cell decomposition for a simple configuration of a capped and bent cylinder;

FIGS. 15-17 show diagrams to aid in the understanding of the bulls eye construction;

FIG. 18 shows two views of an example of a monkey saddle;

FIG. 19a shows the Reeb graph of a standard torus;

FIG. 19b schematically illustrates a 2D cell suspension that is induced from the axes and planes of symmetry and critical point theory;

FIG. 20 is cross section of the torus shown in FIG. 19a;

FIG. 21 is a schematic of the shape synopsis diagram of the torus shown in FIG. 19a;

FIG. 22 is a cyclide that is shaded according to Gaussian and mean curvature;

FIG. 23a is a bi-torus with its associated REEB diagram;

FIG. 23b is the visual representation of the bi-torus shape synopsis diagram;

FIG. 24 is a diagram of the octree with a coarse level and leaf level shape index relationship indicated;

The FIG. 25 is a diagram shows part of the French model;

FIG. 26 is an image of the topography of Crater Lake, Oreg.;

FIG. 27 shows a salt weld in the Gulf of Mexico;

FIGS. 28a-c illustrate an example of the misfit reduction process;

FIGS. 29a-c illustrates an example of blending a non-differentiable join of two collars;

FIG. 30 shows as a geological example a water breach as indicated by the white arrow;

FIG. 31 is a NASA Shuttle Mission photograph of the Richat Structure in Mauritania;

FIG. 32 shows the natural analog to a conformal grid with a proportionally spaced correlation scheme;

FIG. 33 illustrates a non-conformal 3D Cartesian grid;

FIG. 34 is an image of the Devil's Potholes, South Africa;

FIG. 35 is an image of the Yukon River delta;

FIGS. 36a and 36b show, for reference, the background Zechstein Salt and the region in the Zechstein where the vsp was acquired;

FIG. 37 show the frame graph that ties the vsp region of interest to the Zechstein Salt background;

FIGS. 38a, 38b, 39a and 39b illustrate the separation of faulted sediments from unfaulted sediments;

FIG. 40 illustrates a time-lapse seismic evolution;

FIG. 41 shows the reference structure for spatial frames to define a topology graph;

FIG. 42 is a schematic illustration of the definition of the variables in the mean curvature estimator;

FIG. 43 is an image of the regularly sampled input surface representing the present example of the top of the salt, rendered by drawing a subset of evenly spaced inlines and crosslines;

FIG. 44 shows the surface when re-sampled by interpolating missing sample points;

FIG. 45 shows the re-sampled surface after 25 iterations of smoothing;

FIG. 46 shows the shape index map for the re-sampled surface after 25 iterations of smoothing;

FIG. 47 shows that there are 33 shapes in the example shown in FIG. 46;

FIG. 48 is a schematic illustration of a system for improved extraction of hydrocarbons from the earth, according a preferred embodiment of the invention;

FIG. 49 shows further detail of a data processor according to preferred embodiments of the invention;

FIG. 50 shows steps in a method for processing data used for hydrocarbon extraction from the earth, according to preferred embodiments of the invention; and

FIG. 51 shows further detail of steps in generating an efficient and robust subdivision of shapes, according to preferred embodiments of the invention.

### DETAILED DESCRIPTION OF THE INVENTION

While Low-level curvature-based methods as applied to implicit surfaces are relatively complicated to develop, they do not suffer numerical stability problems. By comparison, on a smooth Riemannian manifold the 3rd derivatives of the square of the signed distance function describes the norm of the 2nd Fundamental Form and the mean curvature. For triangulated surfaces, this result is difficult to apply, because numerical evaluation of 3rd derivatives is not guaranteed to be numerically stable.

According to the invention, differential geometry methods of surface representation will now be described. Many geoscience phenomena are related to some form of fluid flow. If the fluid phenomena under study involve surface tension, then mean curvature flow (mcf) and variants such as volume preserving mean curvature flow (vpmcf) are accurate modeling tools. (For those unfamiliar with mean curvature flow, imagine the fluid front moving normal to each particle of the fluid front.) The behavior of mcf and vpmcf are well understood when either is applied to a smooth convex surface, star-shaped surface, a surface of rotation, or an entire graph.

A reservoir structural framework does not seem to be an ideal input to mcf, because noise levels degrade the accuracy of analytical approximations and framework surfaces in general are not well approximated as convex, star-shaped, etc. This perception is erroneous. Our investigation of curvature-based modeling shows that mcf, can be used to semi-automate its own noise suppression. Given smooth surface data, according to the invention a method is provided to decompose that surface into a connected sum of star-shaped or entire graph or axisymmetric surface patches.

The mathematical foundation of mcf is substantial, so we seek a unified mathematical description of shape and its evolution. The concept of a fibre bundle is satisfactory. Nakahara presents a formal definition of a fibre bundle. Standard examples of fibre bundles are vector fields, e.g., velocity fields, and tensor fields, e.g., stress fields and elastic fields, evaluated over a sub-volume. In classical differential geometry, curvature properties of surfaces are economically studied in a fibre bundle setting. We have found that a 4D fibre bundle representation of a reservoir framework is no more difficult to write down than is a 3D fibre bundle representations. The economy of mathematical representation is attractive now from the research view. It will be attractive from the engineering view, since reuse of concepts limits the amount of technology that must be mastered.

The fibre bundle representation of a surface of revolution has the following parts.
1. A base that is homeomorphic to a loop, e.g., a circle, an ellipse, or a polygonal closed curve.
2. A typical fibre that is homeomorphic to a compact connected part of either a conic section or a polygonal line.
3. A structure-group that is a group of diffeomorphisms that smoothly deforms any instance of the typical fibre to any other instance.

Here are a few shapes that are frequently encountered in earth modeling represented as fibre bundles.
a. A torus has a circle base and a circle typical fibre. Its structure group is the rotation group SO(3).
b. A cyclide is a torus, but the structure group is the rotation group extended by the scale factor diagonal group. Intuitively, it is a skewed torus.
c. Any compact planar region R with a polygonal boundary ∂R has a natural bundle structure. To see this, compute the region's bounding box B and embed R in B. (Think of B as a solid.) If there exists a part of ∂R that does not intersect any of the box faces, then attach a skirt S of normal rays to ∂. Then S, R, and ∂B enclose a sub-volume V.

We have found that V is the preferred bundle. The base of the bundle is ∂R and a typical fibre is a polygonal line. The region R is formed from the rotation of a line segment emanating from the centroid of R and joined to the boundary ∂R. The length of the fibre changes instantaneously. The structure group is the Euclidean group of rigid body transformations. The following diagram summarizes this construction.

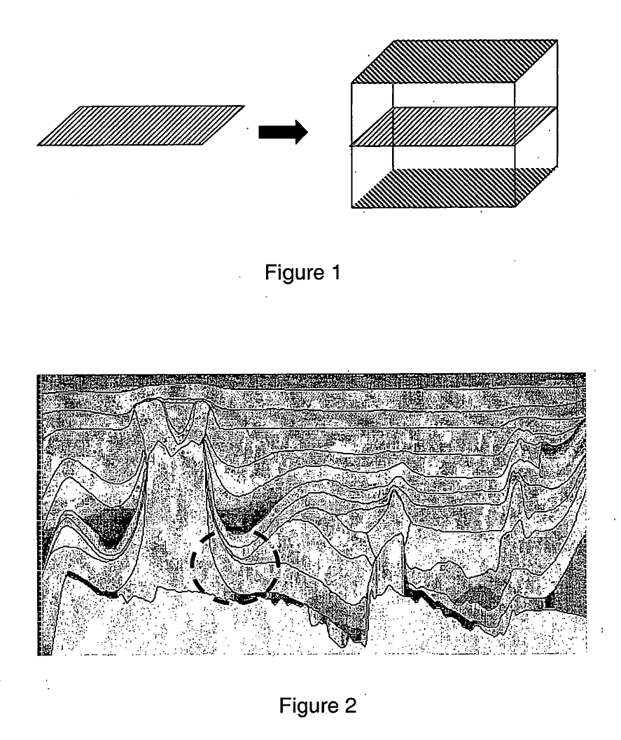

FIG. 1 shows on the left an open surface, i.e. a surface that does not enclose space; on the right, a closed region (the large box) is subdivided by the same surface forming an internal boundary. FIG. 2 shows a salt mass's steep flanks and overhangs, it also shows an example of the cyclide shape in depth imaging. This is an example that challenges existing commercial software. WesternGeco commercial processing used to construct this velocity model has the common limitation of accepting single z-valued (“height field”) data only. According to the invention we describe below a set of planes in the volume of interest such that a multiple z-value body can be subdivided into sections such that each section is single valued with respect to one of the planes. In other words, each plane parameterizes a section of the reference multi z-valued surface. Each of these planes are equipped with a rotation matrix and translation vector so that the application can orient the surface section so that it appears to be single valued with respect to one of the coordinate planes. (It may be that the rotated and translated section is normal to the (x,y) coordinate plane, which is frequently unacceptable to grid-based applications.)

Material properties of a volume of earth can change during an evolutionary process. The time scale of the evolution can vary from wall clock to calendar to geological record. According to the invention, an evolutionary process is represented using a generalization of the fibre bundle method that is employed for shape. This representation is called an “evolutionary process”. Here are its components.
1. The base is a line with period λ_{B}. A trajectory on the base serves as a clock. The trajectory's sampling increment has units that are appropriate to wall clock sampling, calendar sampling, or geological record sampling.
2. A trajectory has compact support. This means that the process is defined on a closed at the beginning and open at the end bounded interval of the helicoid.
3. Two evolutionary processes P₁ and P₂ can be summed if and only if on a shared interval of the base helicoid P₁ followed by P₂ is identical to P₂ followed by P₁. The sum of P₁ and P₂ is P1(t)[P2(t)[v]], where t is a point in time and v is a point in the volume domain of interest.
4. A fibre is a compact path-connected sub-volume. A fibre is associated to each base point. In other words the process time stamps every sub-volume that it affects.
5. A structure group is a 1-parameter subgroup of diffeomorphisms that define an evolution, e.g., vpmcf. Since the structure group consists of diffeomorphisms the process must be invertible. In particular, the process cannot induce singularities in material space. It is preferable to support singularities, so we allow singularities to develop at the end of a process's time interval.

We emphasize that we seek only a geometrical evolution—not necessarily the true physical evolution—that describes part of the structural framework. In the following example, we recognize uniformly expanding mean curvature flow creates the shape of the individual layers. Each discontinuity in the sediment terminates the current flow model and is part of the initial conditions that define the new flow. The ensemble of flow problems describes the formation, but a more economical representation can be defined if we can treat the entire set of restricted flow problems as a single mean curvature flow problem where evolution continues beyond the intermediate singularities. We look for an evolution of the set of initial conditions for the individual flow problems, given just the oldest sediment as an initial condition.

We describe a sedimentary sequence as a 4D fibre bundle.
1. The base of the bundle is a finite length piecewise linear curve.
2. A fibre is an infinitesimal layer of sediment.
3. The bundle's structure group is a set of diffeomorphism groups such that each group defines an instance of uniformly expanding mean curvature flow. Each leg of the bundle base defines a separate mean curvature flow problem. The transition between mcf problems is exactly matched by the discontinuity in the sediment.

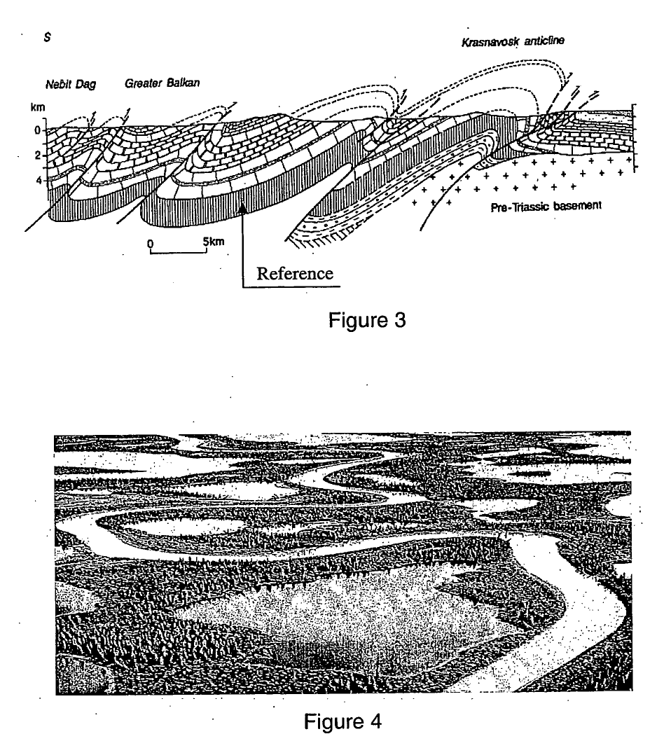

FIG. 3 shows an example of a 4D representation of a field in Turkmanistan. Each layer is a distinct mean curvature flow where the discontinuity is a curvature flow terminator. Working backwards from a flow termination, we see that it is much easier to identify the flow components in the image. Each flow component is a uniformly expanding set of solutions to mean curvature flow (or volume-preserving mean curvature flow). Ecker shows in his lecture notes that mean curvature flow can evolve cracks and holes in a smooth background. See, K. Ecker, Lectures on Regularity for Mean Curvature Flow, http://web.mathematik.unifreiburg.de/mi/analysis/lehre/WS 0001/Ecker_WS0001.ps.

Therefore its usefulness is not limited to modeling smooth elastic behavior.

According to the invention, we show how to construct a meandering river as a fibre bundle. FIG. 4 is an image of the MacKenzie River Delta.

In FIG. 4, the river does not intersect itself, i.e., no oxbow structures are evident. Also, the river appears to have constant width. The structure as a fibre bundle is clear.
1. The bundle base is a line segment.
2. The fibre is any convenient approximation of the river channel in cross section, e.g., a trapezoid;
3. The structure group is the extended Euclidean group, which consists of rigid body motion plus scaling.

At each point along the channel we measure the cross section and record its position relative to the image coordinate axes whose origin is the lower left corner of the picture. Given the previous position of the cross section, we compute the update to the (x,y) plane rotation and translation.

We turn now to the question of recognizing the elementary shape basis elements in an implicit surface representation. Recall that we represent an implicit surface as the zero level set of the signed distance function (sdf). Our constructor solves the signed distance function on a 3D structured grid with tri-linear interpolation as a local approximation to sdf.

By definition tri-linear interpolation T(x,y,z) on a grid cell is
T(x,y,z)=A₀+A₁x+A₂y+A₃z+A₄xy+A₅yz+A₆xz+A₇xvz.

where the coefficients {Aₖ} are defined on the grid cell corners.

Each term in T(x,y,z) is an independent 3D spherical harmonic polynomial in Cartesian coordinates. For convenience we enumerate these spherical harmonic polynomials, using the classical Yₘₙ notation. (See R. Baerheim, Coordinate Free Representation of the Hierarchically Symmetric Tensor of Rank 4 in Determination of Symmetry, Ph.D. thesis, University of Utrecht, #159, 1998, Appendix, pg. 141-143).

| Y(m, n) | Monomial |
|---|---|
| Y(0, 0) | 1 |
| Y(0, 1) | z |
| Real(Y(1, 1)) | x |
| Imag(Y(1, 1)) | y |
| Real(Y(2, 1)) | xz |
| Imag(Y(2, 1)) | yz |
| Imag(Y(2, 2)) | xy |
| Imag(Y(3, 2)) | xyz |

Here are the associated symmetry transformations and the corresponding isomorphism groups involving these spherical harmonic polynomials.

| Term | Symmetry generators | Symmetry group |
|---|---|---|
| Constant | Constant | SO(3) |
| X | [x]˜[x] | SO(2) |
| Y | [y]˜[y] | SO(2) |
| Z | [z]˜[z] | SO(2) |
| X + Y | [x, y]˜[y, x] | Z/2Z |
| X + Y + XY | | |
| Y + Z | [y, z]˜[z, y] | Z/2Z |
| Y + Z + YZ | | |
| X + Z | [x, z]˜[z, x] | Z/2Z |
| X + Z + XZ | | |
| X + Y + Z | [x, y, z]˜[y, z, x] | Tetrahedron |
| | [x, y]˜[y, x] | group of order 12 |
| XYZ | [x, y, z]˜[y, z, x] | Symmetric(4) |
| | [y, z]˜[−y, −z] | |
| | [x, y]˜[y, x] | |
| XY | [x, y]˜[−x, −y] | Z/2Z ⊕ Z/2Z |
| | [x, y]˜[y, x] | |
| YZ | [y, z]˜[−y, −z] | |
| | [y, z]˜[z, y] | |
| XZ | [x, z]˜[−x −z] | |
| | [x, z]˜[z, x] | |
| XY + XZ | [x, y, z]˜[−x, −y, −z] | Z/2Z ⊕ Z/2Z |
| | [y, z]˜[z, y] | |
| XZ + YZ | [x, y, z]˜[−x, −y, −z] | |
| | [x, y]˜[y, x] | |
| XY + YZ | [x, y, z]˜[−x, −y, −z] | |
| | [x, z]˜[z, x] | |
| XY + YZ + ZX | [x, y, z]˜[−x, −y, −z] | Symmetric(4) |
| | [x, y, z]˜[y, z, x] | |
| | [x, y]˜[y, x] | |

Symmetry analysis is a form of spectral analysis applied to the discrete spectrum that is associated with spherical harmonic polynomial expansions. Our estimates of tri-linear interpolation coefficients are noisy, so we need a threshold for dismissing spectral lines.

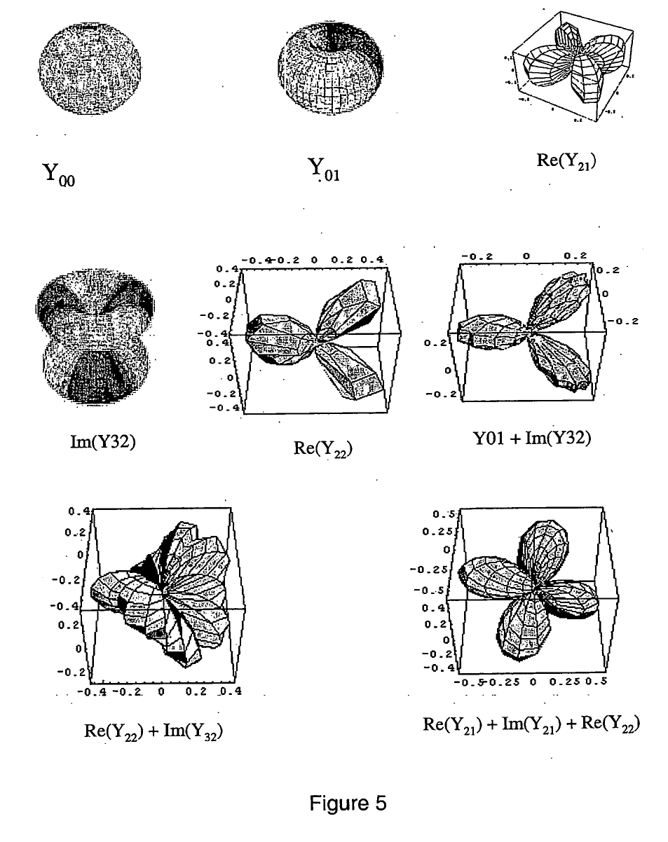

FIG. 5 shows some combinations of involved spherical harmonic polynomials, presented in spherical polar coordinates.

We are interested in conic section fibre bundle shapes. Here is the correspondence of shape to symmetry group.

| Symmetry group | Candidate shapes |
|---|---|
| SO(3) | Sphere |
| O(2) | Cylinder, spherical torus, |
| | elliptical torus, hyperboloid |
| SO(2) | Cone, paraboloid |
| Symmetric(4) | Cube |
| Dihedral(4) | Ellipsoid |
| Dihedral(3) | Triangular prism |
| Z₂ ⊕ Z₂ | Rectangular prism |
| Z₂ | Cyclide |
| {1} | Noisy data |

According to the invention, mean curvature flow and volume-preserving mean curvature flow will now be discussed in further detail. We define a few terms that appear frequently herein. Given a 2D manifold M and a point pεM, let {p₁, p₂} be a local coordinate system for a region containing p and let n be an outward pointing normal at p. Finally the Euclidean inner product of vector Uᵢ and Vⱼ is denoted by <Uᵢ, Vⱼ>.

Definitions

The First Fundamental Form (1^{st} FF) is

$${g}_{ij} = 〈 \frac{\partial M}{\partial {p}^{i}} , \frac{\partial m}{\partial {p}^{j}} 〉 .$$

The inverse of the 1^{st} FF is denoted by g^{ij}.
The Second Fundamental Form (2^{nd} FF) is

$$A = [ {h}_{ij} ] = - 〈 \frac{{\partial }^{2} M}{{\partial }^{2} {p}^{i} {p}^{j}} , n 〉 .$$

The Weingarten map is Wᵢ^{j}=g^{jk}hₖᵢ. (Einstein notation used.)

The eigenvalues of the Weingarten map are the principal curvatures. The trace of the map is the mean curvature, the determinant of the map is the Gaussian curvature. The norm of the 2^{nd} FF |A|² is defined as the sum of the squares of the principal curvatures.

We define mean curvature flow and volume-preserving mean curvature flow.

Notation

(Mₜ) is a family of evolving smooth 2D manifolds such that M=M₀ is given.

N(x,t) is the normal at xεMₜ.

H(x,t) is the mean curvature evaluated at xεMₜ.

h(t) is the average value of H(x,t) on Mₜ.

Mean curvature flow (mcf) is defined as the solution to the initial and boundary value problem

$$\frac{\partial {M}_{t}}{\partial t} = - H ( x , t ) \cdot N ( x , t ) . \qquad [ 4 ]$$

Volume-preserving mean curvature flow (vpmcf) is defined as the solution to the initial and boundary value

$$\frac{\partial {M}_{t}}{\partial t} = - ( H ( x , t ) - h ( t ) ) \cdot N ( x , t ) . \qquad [ 5 ]$$

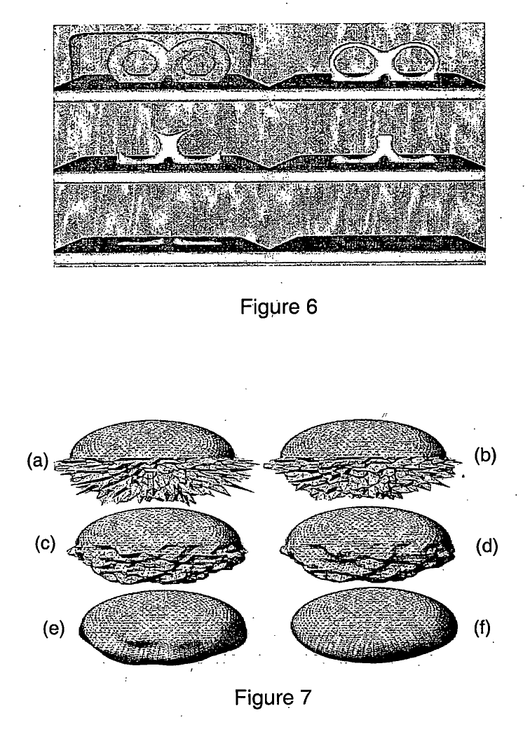

FIG. 6 illustrates that, except in ideal circumstances (when the input is a smooth closed-convex region or a graph), a surface evolves under mcf to a point. Technically, mcf develops a singularity in finite time. See, K. Museth, D. Breen, R. Whitaker, A. Barr, Level Set Surface Editing Operators, SIGGRAPH 2002.

A straightforward way to prevent annihilation of this shape is to stop the mcf after some number of time steps, inspect the results, and maybe resume the process. This is not convenient in a production environment. In fact, the manner in which uncontrolled mcf annihilates a shape enables us to attach a recognition procedure that mcf can call to decide when to ask the human for permission to resume the figure's evolution.

FIGS. 7a-f forms a series of six images showing vpmcf suppressing noise. See, A. Kuprat, A. Khamayseh, D. George, L. Larkey, Volume Conserving for Piecewise Linear Curves, Surfaces, and Triple Lines, Journal of Computational Physics, 172 (2001), pg. 98-118. In FIG. 7a, the southern hemisphere is corrupted with a significant amount of Gaussian noise. By FIG. 7c, it makes sense to consider how much additional noise, if any, must be removed before the smoothed result is an acceptable approximation.

We are interested in surfaces of revolution. The following result has been obtained regarding the behaviour of surfaces of rotation under vpmcf. See, M. Athanassenas, Volume-preserving mean curvature flow of rotationally symmetric surfaces, Comment. Math. Helv. 72(1997), pg. 52-66.

Theorem (Athanassenas)

Let M₀ be a smooth rotationally symmetric surface enclosing a sub-volume V. Let S be a slab of thickness τ>0 that is bounded by the z=0 and z=τ height field planes. Suppose that M₀ satisfies the following two conditions.
a. M₀ has a line of intersection in the z=0 and z=τ height field planes.
b. The end points of each line of intersection between M₀ and S meet an end of M₀ at a right angle.

If the volume of V is greater than τ times the area of M, then Mₜ evolves under vpmcf to a cylinder.

As an example of the condition on the lower bound on volume, consider the case of a right cylinder of height τ and radius r. This cylinder has volume V equal to πr²τ, while its surface area M is equal to 2πrτ. Hence the lower bound on the volume is satisfied exactly when πr²τ≧2πrτ², i.e, r≧2τ. Heuristically, the bound is satisfied for “squat” cylinders. We observe that a sphere cannot satisfy the volume to area relationship. To do so would imply that there exists r>0 such that

$$\frac{4}{3} π {r}^{3} / 4 π {r}^{2} = \frac{r}{3} \geq 2 r .$$

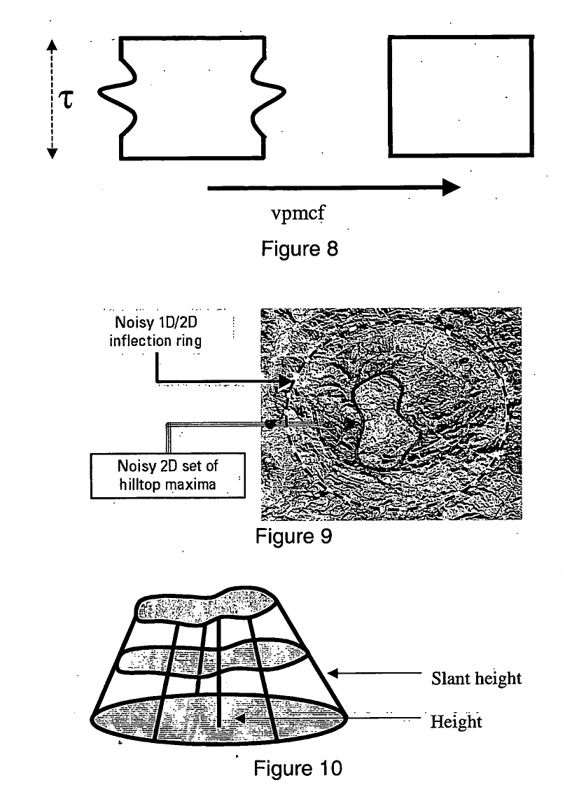

FIG. 8 illustrates the orthogonality condition of the theorem proposed by Athanassenas. In this diagram we show two vertical cross-sections. In the figure on the left the intersection of the figure with the top and bottom planes must satisfy the right angle hypothesis. The curvature flow takes care of the irregular vertical surfaces either end of the figure. In finite time vpmcf generates from the figure on the left the figure on the right.

Volume preservation is essential for earth model applications, so we prefer vpmcf to ordinary mcf. Later in the description, we will use this theorem to reduce the discrepancy between an idealized representation of shape and a sampled data surface.

Another important class of smooth surfaces are those that are star-shaped. A surface is star-shaped if there exists a point P on the surface such that a line segment PQ that is entirely contained in the surface can join every other point Q in the surface.

It has been shown that star-shaped closed smooth surfaces are stable under mcf. See, K. Smocyzk, Star-shaped hypersurfaces and the mean curvature flow, Manuscripta Math. 95 (1998), pg. 225-236.

We show now that vpmcf suppresses additive high frequency harmonics before decaying the underlying low frequency shape signal. Vpmcf enjoys the property that surface area is always decreasing in time.

$$\frac{ⅆ \vert {M}_{t} \vert}{ⅆ t} = - {\int }_{M} {( H - h )}^{2} ⅆ {g}_{t} \leq 0. \qquad [ 6 ]$$

We frequently need to compute mean and Gaussian curvature for a single valued surface over a plane, i.e., a graph. Suppose that S=S(x,y). Then the formulae for mean curvature H and Gaussian curvature K are as follows.

$$K = \frac{{s}_{xx} {s}_{yy} - {s}_{xy}^{2}}{{( 1 + {s}_{x}^{2} + {s}_{y}^{2} )}^{2}} \\ and \\ H = \frac{1}{2} \frac{( 1 + {s}_{x}^{2} ) {s}_{yy} - 2 {s}_{x} {s}_{y} {s}_{xy} + ( 1 + {s}_{y}^{2} ) {s}_{xx}}{{( \sqrt{1 + {s}_{x}^{2} + {s}_{y}^{2}} )}^{3}} \qquad [ 7 ]$$

We model a surface as a collection of patches, where each patch is taken from a surface of revolution, say S=(φ(v)*cos u, φ(v)*sin u, ψ(v)), such that vε(a,b), uε(0,2π), and ψ(v)≠0. The formulae for mean curvature H and Gaussian curvature K for a surface of revolution is as follows.

$$K = - \frac{{ϕ}^{′′}}{ϕ} \\ and \\ H = \frac{1}{2} \frac{- {ψ}^{′} + ϕ ( {ψ}^{′} {ϕ}^{′′} - {ψ}^{′′} {ϕ}^{′} )}{ϕ} \qquad [ 8 ]$$

For the proofs, see, M. do Carmo, Differential Geometry of Curves and Surfaces, Prentice Hall, 1976, pages 162-163.

We need to understand how mcf behaves when applied to a noisy surface S, where S is either single valued over a plane or is a surface of revolution. The above formulae imply that if S is an entire graph, then the harmonic number N scales the mean curvature. Similarly, if S is a surface of revolution, then N² scales the mean curvature. (Spherical harmonic polynomials have a cosine factor, so these estimates remain valid under the natural heat equation eigen-function expansion.) Consequently, the mean curvature integral involves a scale factor of either N² or N⁴. Therefore the rate of change of surface area becomes very negative as N increases. We conclude that vpmcf eliminates high frequency harmonics during the initial stages of the evolution ahead of low frequency harmonics that form the ideal shape. A maximum or minimum in the ideal shape will appear to move as vpmcf eliminates corrupting noise, but the critical point's location will stabilize as the noise disappears. Importantly, when a critical point's location stabilizes, it does not move later in the evolution unless vpmcf begins to decay the shape. We remark that mcf can be turned off locally by resetting the mean curvature to zero.

We turn now to the question of how to decide when noise suppression turns into shape decay. Refer again to FIGS. 7a-f, which show the smoothing of a noisy sphere under vpmcf. Athanassenas's theorem does not apply, since the sphere fails the volume bound assumption. However, it still makes sense to apply Kuprat et al.'s vpmcf procedure to the shape. When we do this we get FIGS. 7c-f.

It is reasonable to say that noise-suppression reduces FIGS. 7a-b to FIGS. 7c-d. It is harder to say if image noise suppression or shape decay accounts for the transformation to FIGS. 7e-f. Therefore, we want vpmcf to proceed without manual intervention to eliminate noise but to seek guidance when the flow causes the underlying shape to decay. Here is a way to monitor the elimination of noise and detect decay of the critical points in an underlying shape that relies on vpmcf.
1. Given a characteristic length, we embed a series of conical shapes in the surface. The base of the cone is either the outermost 1D boundary of the surface or it is an inflection point curve surrounding the patch that contains the maximum or minimum.
2. We recognize minima and maxima in its 2D enclosure using a standard nested bounding box algorithm. If the surface is implicit, then we can localize the region by testing the implicit surface's triangulated parent.
3. Use this 2D enclosure as the top of the (noisy) cone. Note that we cannot assume that each maximum or minimum is topologically isolated, e.g., a ridge might exist.
4. Apply any mean curvature flow procedure, e.g., D3b, to the surface and monitor the effect on the cone's slant height. Mean curvature flow theory says that the slant height decreases as the noise is removed (it becomes straighter). However, when the mean curvature flow begins to destroy the intrinsic shape of the surface in the vicinity of the cone, then the slant height will decrease beyond a threshold. Therefore, the test for adequate smoothing is to compare the ratio of slant height before smoothing to the result obtained after each iteration.

FIG. 9 is an aerial image of part of Big Bend National Park, showing the approximation of a plateau to a characteristic length scale cone. It is difficult to precisely locate the maxima on the plateau, but it is easy to enclose the region containing the maxima in a tight loop. It is unimportant that the cone does not have a circular cross section.

FIG. 10 is a side view of a noise cone structure. When monitoring noise suppression on the surface of a geobody, e.g., it is useful to have a noise-monitoring device for thin undulating cross section. We replace a torus by a cone. We use the cone to monitor shear stretching and erosion of an interface. A clear instance of this phenomenon is FIG. 7c.

According to the invention, mean curvature flow and framework I/O will now be discussed in further detail. Singularities mark an end to the smooth evolution of a shape under mcf. A singularity is frequently easier to identify on an image than is the interface that corresponds to the precise start of the flow. The flow imposes a natural partition of the framework. Each region in the partition is a self-contained expression of mcf. When we think about sending and receiving an update to a framework, we prefer to send and receive a mcf problem with boundary conditions rather than an opaque byte stream. We specify the solution form—whether the flow uniformly expands or contracts the solution or smoothes the initial data—and provide beginning and end surface data. We describe the intermediate surfaces by recording the time states that correspond to the intermediate surfaces. We also send critical point data for each intermediate surface. Interested applications run the vpmcf script and reconstruct the update locally. We trade fast CPU for less fast. I/O.

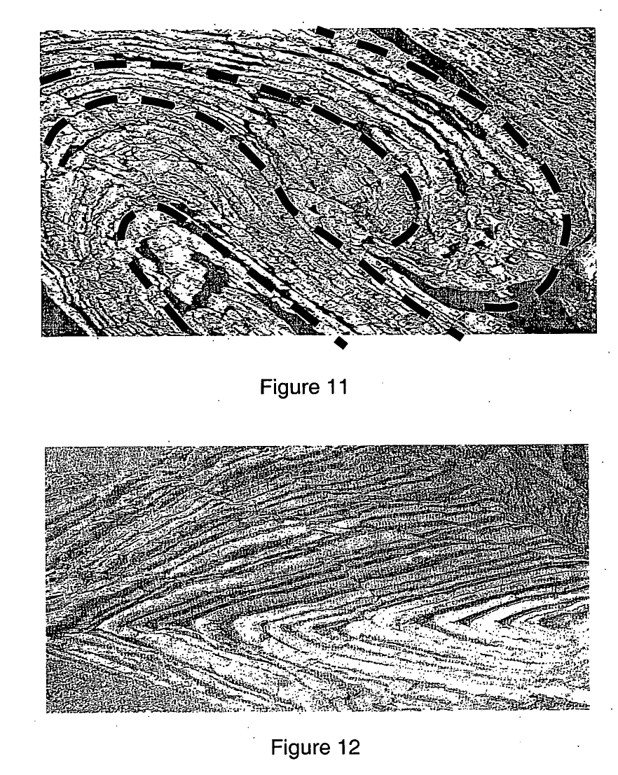

Here are three illustrations of this idea. FIG. 11 is a NASA satellite image of the Labrador Trough. In this image we notice that the sediment resembles a longitudinal cross section of a brain with an attached spinal cord. Singularities separate “brain tissue” from the stem of the “spinal cord”. A singularity also subdivides the “cerebellum”.

FIG. 12 shows s a sequence of folded sediment on the coast of the Gulf of Oman. We model this as a uniformly expanding (seen right to left) solution to mcf. Ecker proved that a uniformly expanding solution to mcf is given by the equation Mₜ=\sqrt{t}·M₁, provided that the initial fold is approximately a cone.

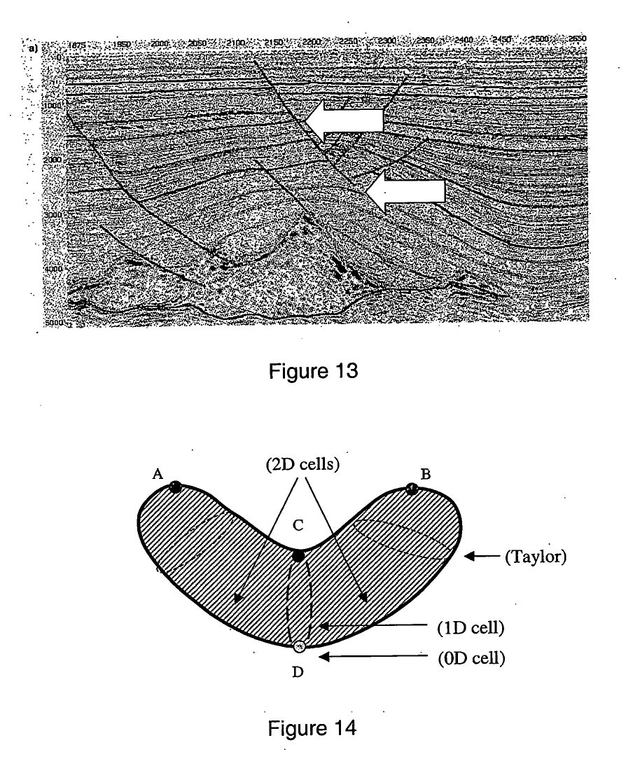

FIG. 13 is an image illustrating progressive flattening of an overburden covering a large salt intrusion. We notice that the fault block that occupies the left half of the image (indicated by the lower white arrow) displays a gradual flattening in space and time as the top of the salt's intrusion is progressively reduced as the sediment was deposited on top of the salt (indicated by the upper white arrow).

According to the invention, a preferred technique of 2D parameterization will now be discussed in further detail. Many surface editing operations are more efficient when the operator can access the surface's parameterisation. Height field data uses the (x,y) coordinate plane as the parameter space and coordinate projection as the parameter space mapping. We explain how to obtain a parameterisation of a smooth surface S with no assumptions regarding the orientation of the surface relative to the (x,y) co-ordinate plane.

We claim that there exists an invertible projection of S onto a cylinder that has 0, 1, or 2 end caps.
1. Given any two closed curves C₁ and C₂ on S. We partially order the two curves, say C₁≦C₂, if there exists a 2D region R₂ on S such that ∂R₂=C₂ and C₁⊂R₂. We call the 2D region of S that is contained between C₂\C₁ the collar that is bounded by C₂ and C₁.
2. From the classification of smooth-surfaces in R³ we know that S has Euler Characteristic χ(S) equal to 0, 1, or 2. The Euler Poincare Theorem says that χ(S)=#(maxima)+#(minima)−#(saddle points). Note that we use height as our Morse function, so the term “critical point” is a contraction for “height field critical point”.
3. We will prove our claim by induction on the number of saddle points on S.
4. Suppose that the number of saddle points on S is zero.
   a. If χ(S)=2, then Reeb's Theorem says that S is diffeomorphic to a round sphere, which is diffeomorphic to a cylinder with two end caps.
   b. If χ(S)=0, then S must be diffeomorphic to a plane which is diffeomorphic to a cylinder with one end cap.
   c. If χ(S)=1 then S has either 1 maximum or 1 minimum but not both.
   d. Construct a 1^{st} order Taylor series with center equal to the critical point and quadratic order error term.
   e. Notice that the gradient term is trivial, since we expand about a minimum or maximum.
   f. We apply a translation to the surface so that expansion point is the origin and has height equal to 0.
   g. We conclude that after a suitable translation and (x,y) plane rotation a 2 term Taylor expansion about the critical point with a quadratic error estimator simplifies to a pure quadratic term.
   h. Given ε>0, we fit the Taylor expansion such that the error estimate is less than ε.
   i. Then the Taylor series expansion within C₀ is a cap/cup. We know that a cap/cup is diffeomorphic to a plane and that a plane is diffeomorphic to cylinder with one end cap. Furthermore, the open end of the cylinder has boundary C₀.
5. Suppose that the number of saddle points on S equals 1.
   a. If χ(S)=2, then S possesses either (i) 2 maxima and 1 minimum or (ii) 2 minima and 1 maximum or (iii) 3 maxima or (iv) 3 minima.
   b. Case (iii) is impossible, because Morse Theory says that a maximum contributes a 2D cell to the shape. If case (iii) were true, then
   c. Case (iv) is impossible, because Morse Theory says that a minimum contributes a 0D cell to the shape. If case (iv) were true, then S contains no 2D cells.

FIG. 14 is a diagram illustrating the Morse theoretical cell decomposition for a simple configuration of a capped and bent cylinder.

Morse Theory explains the cell decomposition of the shape. (See M. Hirsch, Differential Topology, Springer Verlag, 1976, pg. 156-164.)
d. This shape has a saddle point at location C.
   i. Morse Theory says that the surface contains a 1D cell that is attached to location C.
   ii. We observe that this 1D cell is not a loop. Specifically, the point at location D is not part of the 1D cell.
e. This shape has a minimum at location D.
   i. Morse Theory says that the shape contains a 0D cell that is attached to location D.
f. This shape contains two maxima at locations A and B.
   i. Morse Theory says that the shape contains two 2D cells, and that each 2D cell is attached to a maximum.
   ii. The boundary between the two 2D cells is the union of the 0D cell that is attached to location D and the 1D cell that is attached to location C.
   iii. We decompose each 2D cell into the union of a Taylor series cap expanded about the maximum and a collar that is bounded by the loop suspended between locations C and D and the Taylor series circle of convergence.
g. Suppose that χ(S)=1. The Euler-Poincare formula says that the surface contains either (i) 1 maximum and 1 minimum or (ii) 2 maxima or (iii) 2 minima.
   i. An example configuration for case (i) is the upper half of a torus.
   ii. An example configuration for case (ii) is a flat surface with two hills.
   iii. An example configuration for case (iii) is a flat surface with two valleys.
h. Finally suppose that χ(S)=0. Then S contains either 1 minimum or 1 maximum, but not both. An example of this configuration is a single mountain or sinkhole attached to a plane.
6. We have specified the parametric mapping when S contains either 0 or 1 saddle point.
7. Now suppose that S contains N−1 saddle points. Choose any saddle point and pass a height field plane through it, subdividing S in two. At least one of the two parts contains fewer saddle points than does S. Define S* to be this part of S.
   a. By induction we know that S* is diffeomorphic to either a cylinder with a hole in its lateral surface, or a cylinder that has 0 or 1 end caps.
   b. Closing the hole in S* corresponds to either closing a hole in the walls of a cylinder or to attaching an end cap to the cylindrical surface that we created in xyz space.

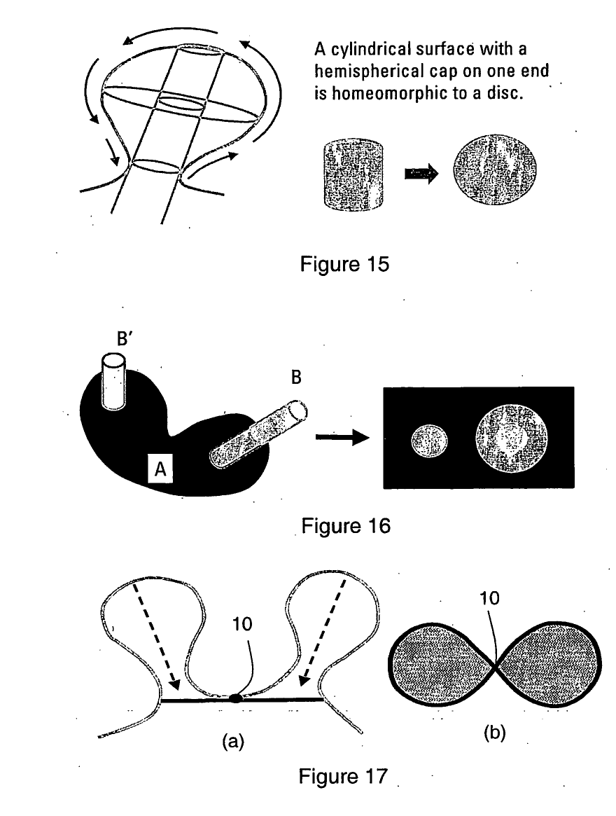

FIGS. 15-17 show diagrams to aid in the understanding of the bulls eye construction. In FIG. 16, we invertibly map the possibly patched A to the planar unfolding of its interior facetted cylinder. FIGS. 17a and 17b illustrates how to perform the bulls eye construction in the region of a saddle point. The saddle point is indicated with the dot 10 in FIGS. 17a and 17b This process is preferably repeated for every saddle point of the shape.

According to the invention, tri-linear interpolation, implicit surfaces, and critical points will now be described in further detail. In particular we herein discuss the analysis of the tri-linear interpolation approximation to the signed distance function on a 3D structured grid. We derive necessary two conditions that the tri-linear interpolator must satisfy if the grid cell contains a height field critical point. One condition specifies a relationship between the tri-linear coefficients and the critical value. The other condition establishes a second relationship among four of the tri-linear coefficients. Taken together, we show that a height field critical point for an implicit surface must be embedded in the grid cell faces and can never be found in the interior of the grid cell unless the implicit surface is a plane.

Let G denote a 3D structured grid with typical grid cell C. We assume that an implicit surface S is contained in G and in particular that C∩S≠0. We denote the tri-linear interpolation function on C by σ and we assume that C is small enough that σ is a good approximation to the signed distance function that implicitly defined S.

We begin with the definition of tri-linear interpolation
σ(x,y,z)=A(x,y)+B(x,y)·z (1)
where
A(x,y)=α₀+α₁x+a₂y+α₃xy
B(x,y)=b₀+b₁x+b₂y+b₃xy. (2)

For later reference, we note that A and B are harmonic, i.e.,
∇²A=∇²B=0 (3)

We are interested in the zeroth level of σ. If σ=0, then either B=0 or B≠0. We suppose that B≠0. Then

$$z = - \frac{A ( x , y )}{B ( x , y )} . \qquad ( 4 )$$

We know that height field critical points are found when

$$\frac{\partial z}{\partial x} = \frac{\partial z}{\partial y} = 0. \qquad ( 5 )$$

This condition is satisfied when

$$B \frac{\partial A}{\partial x} - A \frac{\partial B}{\partial x} = 0 \\ B \frac{\partial A}{\partial y} - A \frac{\partial B}{\partial y} = 0 \qquad ( 6 )$$

Rewriting (6)

$$\frac{A}{B} = \frac{\frac{\partial A}{\partial x}}{\frac{\partial B}{\partial x}} = \frac{\frac{\partial A}{\partial y}}{\frac{\partial B}{\partial y}} \qquad ( 7 )$$

Using (7)

$$\begin{matrix}\begin{matrix}\frac{\partial }{\partial y} ( B \frac{\partial A}{\partial x} - A \frac{\partial B}{\partial x} ) = ( \frac{\partial B}{\partial y} \cdot \frac{\partial A}{\partial x} - \frac{\partial B}{\partial x} \cdot \frac{\partial A}{\partial y} ) + ( {Ba}_{3} - {Ab}_{3} ) \\ = ( {Ba}_{3} - {Ab}_{3} ) \\ = 0.\end{matrix} & ( 8 )\end{matrix}$$

The Hessian matrix of 2^{nd} partial derivatives evaluated at the critical point is

$$\frac{{\partial }^{2} z}{\partial {x}^{2}} = \frac{- 2 B \frac{\partial B}{\partial x} ( B \frac{\partial A}{\partial x} - A \frac{\partial B}{\partial x} )}{{B}^{4}} = 0 \\ \frac{{\partial }^{2} z}{\partial {y}^{2}} = \frac{- 2 B \frac{\partial B}{\partial y} ( B \frac{\partial A}{\partial y} - A \frac{\partial B}{\partial y} )}{{B}^{4}} = 0 \\ \frac{{\partial }^{2} z}{\partial x \partial y} = \frac{B \frac{{\partial }^{2} A}{\partial x \partial y} - A \frac{{\partial }^{2} B}{\partial x \partial y}}{{B}^{4}} = \frac{{Ba}_{3} - {Ab}_{3}}{{B}^{4}} = 0. \qquad ( 9 )$$

We conclude that the Hessian matrix of 2^{nd} partial derivatives is identically zero. We are led to consider what kinds of shape have the property that in a local neighborhood of a critical point the matrix of second partial derivatives is identically zero.

We have enough information to compute the Gaussian curvature of z=z(x,y). Recall that for a graph z=z(x,y) that its Gaussian curvature K(x,y) is

$$K ( x , y ) = \frac{\frac{{\partial }^{2} z}{\partial {x}^{2}} \cdot \frac{{\partial }^{2} z}{\partial {y}^{2}} - {( \frac{{\partial }^{2} z}{\partial x \partial y} )}^{2}}{{( 1 + {( \frac{\partial z}{\partial x} )}^{2} + {( \frac{\partial z}{\partial y} )}^{2} )}^{2}} \qquad ( 10 )$$

We notice that the signum of K(x,y) depends only on its numerator. Substituting (3) into the numerator of (9), we discover that the numerator of K(x,y) is

$$- {( \frac{\partial {z}^{2}}{\partial x \partial y} )}^{2} = - ( B \cdot {a}_{3} - A \cdot {b}_{3} ) + ( \frac{\partial A}{\partial y} \cdot \frac{\partial B}{\partial x} + \frac{\partial A}{\partial x} \cdot \frac{\partial B}{\partial y} ) \qquad ( 11 )$$

Hence the Gaussian curvature K(x,y)≦0 everywhere.

As an illustration we consider the “monkey saddle” M(x,y), which coincidentally is also a spherical harmonic polynomial M(x,y)=Re(Y₃₃)=.x³−3xy². The monkey saddle has a single critical point, which is the origin (0,0). The matrix D of 2^{nd} partial derivatives is

$$D = [ \begin{matrix}6 x & - 6 y \\ - 6 y & - 6 x\end{matrix} ] . \qquad ( 12 )$$

Substituting (x,y)=(0,0), we find that the 2^{nd} partial derivatives matrix is identically 0. We conclude that the origin is a degenerate saddle point for M(x,y).

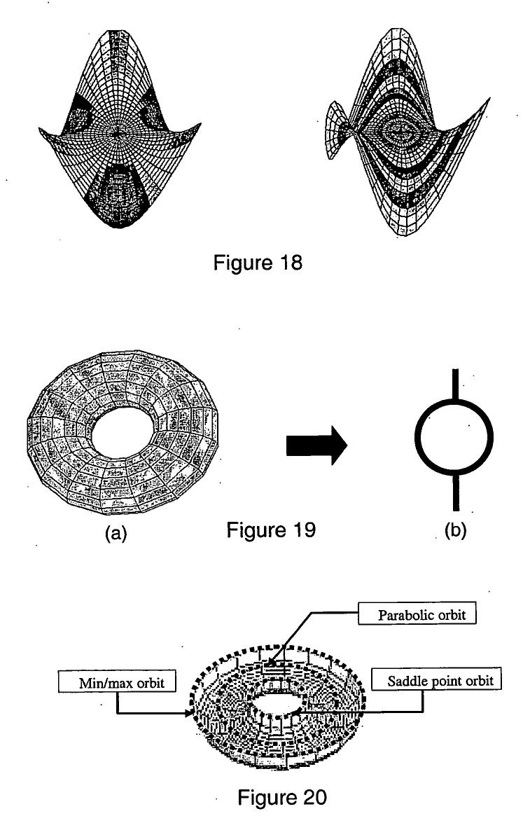

FIG. 18 shows two views of an example of a monkey saddle. In particular the monkey saddle is M(x,y) given by the equation above. The image on the left is shaded according to mean curvature, while the image on the right is shaded according to Gaussian curvature. We have placed a white dotted circle around the critical point.

The critical point is a degenerate saddle point. We see this by substituting the samples defined by the white circle and observing the pattern of +/−signs. As an example, let 0<a<b. Then ((+/−)a, (+/−)b) produces the pattern (−,−), (−,+), (−,−), and (−,+) clockwise from Quadrant I.

The Gaussian curvature of the monkey saddle is (Gray, pages 382-383)

$$K ( x , y ) = - \frac{36 ( {x}^{2} + {y}^{2} )}{{( 1 + 9 {x}^{4} + 18 {x}^{2} {y}^{2} + 9 {y}^{4} )}^{2}} \qquad ( 13 )$$

(See, A. Gray, Modern Differential Geometry of Curves and Surfaces with Mathematica 2^{nd} Edition, CRC Press, 1998, pages 382-383).

Summarizing the analysis for B≠0, we have shown the following.
1. A grid cell contains at most one height field critical point.
2. If a grid cell does contain a critical point, then the critical point's coordinates are uniquely determined from the tri-linear interpolator's coefficients. We use this as a quick test for assessing the existence of a critical point in a grid cell.
3. The matrix of 2^{nd} partial derivatives is identically zero when evaluated at the critical point.
4. The Gaussian curvature K(x,y)≦0 and equals zero exactly at the critical point.
5. z=z(x,y) is harmonic, so by the Maximum Principle for harmonic functions on compact sets, we know that the minimum and maximum value for z on a grid cell will be found on the grid cell corners.

It has been remarked that the behavior of the tri-linear interpolation function is determined in the region of a critical point by the behavior of

$$\frac{\partial z}{\partial x} , \frac{\partial z}{\partial y} , and \frac{\partial z}{\partial z} .$$

See, G. Weber, G. Scheuermann, H. Hagen, B. Hamann, Exploring Scalar Fields Using Critical Isovalues, http://graphics.cs.ucdavis.edu/˜hamann/WeberScheuermannHagenHa mann2002.pdf (“Weber”). We agree, which is Morse Theory should be applied.

Weber shows that a tri-linear interpolation function can have a critical point on the edge of a grid cell if and only if the tri-linear interpolation function is constant along the edge. Weber does not assume that the tri-linear interpolation approximates a signed distance function. Weber also obtains a simple test for the existence of a maximum at grid cell vertex (0,0,0) by looking at the value of the function at the tetrahedral corners (1,0,0), (0,1,0), and (0,0,1).

In our situation Weber's condition says that a₀>max (a₁, a₂, b₀) implies that (0,0,0) is a maximum of T(x,y,z)=A(x,y)+B(x,y)*z. We note that T(0,0,0)=a₀ and that

$$\frac{\partial T}{\partial x} {\vert}_{( 0 , 0 , 0 )} = 0 \\ \frac{\partial T}{\partial y} {\vert}_{( 0 , 0 , 0 )} = 0 \\ \frac{\partial T}{\partial z} {\vert}_{( 0 , 0 , 0 )} = B ( 0 , 0 ) = {b}_{0} \qquad ( 14 )$$

Checking 2^{nd} mixed partials

$$\frac{{\partial }^{2} T}{\partial {x}^{2}} = \frac{{\partial }^{2} A}{\partial {x}^{2}} + z \cdot \frac{{\partial }^{2} B}{\partial {x}^{2}} = 0 \\ \frac{{\partial }^{2} T}{\partial {y}^{2}} = \frac{{\partial }^{2} A}{\partial {y}^{2}} + z \cdot \frac{{\partial }^{2} B}{\partial {y}^{2}} = 0 \\ \frac{{\partial }^{2} T}{\partial {z}^{2}} = 0 \\ \frac{{\partial }^{2} T}{\partial x \partial y} = \frac{{\partial }^{2} A}{\partial x \partial y} + z \cdot \frac{{\partial }^{2} B}{\partial x \partial y} = {a}_{3} \\ \frac{{\partial }^{2} T}{\partial x \partial z} = \frac{\partial B}{\partial x} = {b}_{1} + {b}_{3} y \\ \frac{{\partial }^{2} T}{\partial y \partial z} = \frac{\partial B}{\partial y} = {b}_{2} + {b}_{3} x \qquad ( 15 )$$

Therefore the first order Taylor series expansion of the tri-linear interpolation function about (0,0,0) inside a grid cell cube is given by the expression

$$\begin{matrix}T ( x , y , z ) = {a}_{0} + {b}_{0} z + ( {b}_{1} {b}_{3} y ) xz + ( {b}_{2} + {b}_{3} x ) yz \\ = {a}_{0} + {b}_{0} z + {b}_{1} xz + {b}_{2} yz + {b}_{3} xyz + {b}_{3} xyz \\ = {a}_{0} + B ( x , y ) z + {b}_{3} xyz\end{matrix} \qquad ( 16 )$$

This says that in a local neighborhood of (0,0,0) that the tri-linear interpolation function is a harmonic polynomial and therefore the Maximum Principle applies. We conclude that on the tetrahedron formed by the four grid cell vertices that maximum occurs at the grid cell vertex a₀ or b₀. We invoke Weber's assumption and conclude that the maximum occurs at a₀. It is not necessary to assume the other inequalities in Weber's assumption.

We consider now the case that σ=0 and B=0. We begin by observing that σ=0 implies that B=0 if and only if A=0. Therefore,

$$y = - \frac{{a}_{0} + {a}_{1} x}{{a}_{2} + {a}_{3} x} = - \frac{{b}_{0} + {b}_{1} x}{{b}_{2} + {b}_{3} x} . \qquad ( 17 )$$

Again we look for solutions to the zero gradient equation.

$$\begin{matrix}\frac{ⅆ y}{ⅆ x} = - \frac{{a}_{1} {a}_{2} - {a}_{0} {a}_{3}}{{( {a}_{2} + {a}_{3} x )}^{2}} \\ = 0 implies that {a}_{1} {a}_{2} - {a}_{0} {a}_{3} \\ = 0\end{matrix} \\ and \\ \begin{matrix}\frac{ⅆ y}{ⅆ x} = - \frac{{b}_{1} {b}_{2} - {b}_{0} {b}_{3}}{{( {b}_{2} + {b}_{3} x )}^{2}} \\ = 0 implies that {b}_{1} {b}_{2} - {b}_{0} {b}_{3} \\ = 0\end{matrix} \qquad ( 18 )$$

Again we obtain a relationship among the tri-linear interpolator coefficients that must be satisfied in order that a grid cell face contain a critical point on a curve running through the grid cell face.

Suppose that a grid cell face contains a critical point of a curve. Again the second derivative

$$\frac{{ⅆ}^{2} y}{ⅆ {x}^{2}} = 0 ,$$

so we characterize the nature of the critical point by sampling the gradient on a tight neighborhood of the critical point.

We conclude that there exists at most 1 critical point on a curve running through a grid cell face and that the (x, y) coordinates of a critical point are uniquely determined in terms of the tri-linear interpolator's coefficients.

According to the invention shape index and shape identification techniques will now be described in further detail. According to a preferred embodiment, shape identification depends on a dimension—independent measure of the principal curvatures at a point known as the Koenderink and van Doorn shape index si.

$$si = \frac{2}{π} arctan \frac{{κ}_{1} + {κ}_{2}}{{κ}_{1} - {κ}_{2}} = \frac{2}{π} arctan \frac{H}{\sqrt{{H}^{2} - K}} , where {κ}_{1} \geq {κ}_{2} .$$

Shown below is a chart of the shape index map's range [−1.0, +1.0], which goes from most concave to most convex. We note that a shape index value of zero corresponds to a zero mean curvature surface, which for the case of a compact surface, equates to a catenoid or a compact planar region.

| Local shape | si interval |
|---|---|
| spherical cup | [−1, −7/8) |
| trough | [ −7/8, −5/8) |
| rut | [ −5/8, −3/8) |
| saddle rut | [ −3/8, −1/8) |
| saddle | [ −1/8, ⅛) |
| saddle ridge | [⅛, ⅜) |
| ridge | [⅜, ⅝) |
| dome | [⅝, ⅞) |
| spherical cap | [⅞, 1] |

Cantzler et al. have computed a correspondence between shape attributes defined by a Gaussian and mean curvature value pair and the shape index map range. See, H. Cantzler, R. Fisher, Comparison of HK and SC curvature description methods, http://www.dai.ed.ac.uk/homes/rbf/hc3dim.ps.gz. See, the following tables.

| | .K < 0 | K = 0 | K > 0 |
|---|---|---|---|
| H < 0 | Saddle Valley | Concave | Concave |
| | (Sv Hy) | Cylinder (−Cy) | Ellipsoid (−El) |
| H = 0 | Minimal | Plane | Impossible |
| | (M Hy) | (Pl) | |
| H > 0 | Saddle Ridse | Convex | Convex |
| | (SrHy) | Cylinder (+Cy) | Ellipsoid (+El) |

| Shape | Index range |
|---|---|
| Concave Ellipsoid (−El) | S ε [−1, −5/8) |
| Concave Cylinder (−Cy) | S ε [−5/8, −3/8) |
| Hyperboloid (Hy) | S ε [−3/8, 3/8) |
| Convex Cylinder (+Cy) | S ε [3/8, 5/8) |
| Convex Ellipsoid (+El) | S ε [5/8, 1] |

As an example, we compute the shape index of a torus.
a. The torus's parameterization is
   ((a+b·cos v)cos u, (a+b·cos v)sin u, b·sin u),
where we assume that a>b>0.
b. The principal curvatures are

$${k}_{1} = - \frac{cos v}{a + b \cdot cos v}$$

$$and$$

$${k}_{2} = - \frac{1}{b} .$$
c. Therefore

$$\frac{{k}_{1} + {k}_{2}}{{k}_{1} - {k}_{2}} = - ( 1 + \frac{2 b}{a} cos v ) .$$
d. This quotient covers the range [−3.0, +1.0]; hence the shape index covers the interval [−0.80, +0.50], which corresponds to “trough” to “ridge”.

Certain principal curvature pairs are distinguished.
1. If κ₂=κ₁, then the shape index is +/−1.0, as the signum(κ₂)=−/+1.
2. If 0=κ₂>κ₁, then the shape index is −½.
3. If κ₂>κ₁=0, then the shape index is ½.
4. If κ₂=−κ₁, then the shape index is 0.
5. The shape index of a maximum is 1.0.
6. The shape index of a minimum is −1.0.
7. If the shape index is discretized in increments of size Δs, then the principal curvatures will be discretized according to the following formulae

Shape index expresses a relationship between principal curvatures. For example, we expect the shape index in the region of an inflection point is approximately ⅛. Plugging into the shape index definition, we discover that

$${κ}_{2} = {κ}_{1} \cdot ( \frac{tan ( \frac{π}{2} \cdot \frac{1}{8} ) - 1}{tan ( \frac{π}{2} \cdot \frac{1}{8} ) + 1} ) = - 0.99023 \cdot {κ}_{1} .$$

The shape index enables a human to express a threshold change in curvature in a dimension-independent manner. This correspondence is fundamental to the robustness of our shape identification scheme. Measurements are always tainted with noise. Therefore it preferable to identify intervals rather than point values for attribute, correspondence.

Definitions

Let A, BεS and let s_{A}, s_{B} be the shape index at A, B.

By definition

$$tan ( \frac{π}{2} \cdot {s}^{A} ) = {θ}^{A}$$

$$and$$

$$tan ( \frac{π}{2} \cdot {s}^{B} ) = {θ}^{B} ,$$

where

$${θ}^{A} = \frac{{κ}_{1}^{A} + {κ}_{2}^{A}}{{κ}_{1}^{A} - {κ}_{2}^{A}} ,$$

where κ₁^{A} and κ₂^{A} are principal curvatures at A. Likewise for θ^{B}.

$$Thus$$

$$tan ( \frac{π}{2} \cdot ( {s}^{B} - {s}^{A} ) ) = \frac{{θ}^{B} - {θ}^{A}}{1 - {θ}^{B} \cdot {θ}^{A}}$$

$$or \\ ( {s}^{B} - {s}^{A} ) = \frac{2}{π} arctan ( \frac{{θ}^{B} - {θ}^{A}}{1 - {θ}^{B} \cdot {θ}^{A}} )$$

This formula relates the shape index principal curvature quotient in shape index increments. For example

$$if \\ ( {s}^{B} - {s}^{A} ) = \frac{1}{8} , \\ then$$

$$tan ( \frac{π}{16} ) = 0.0034 = \frac{{θ}^{B} - {θ}^{A}}{1 - {θ}^{B} \cdot {θ}^{A}} .$$

Holding θ^{A} fixed, then

$$tan ( \frac{π}{16} ) \cdot ( 1 - {θ}^{B} {θ}^{A} ) = {θ}^{B} - {θ}^{A}$$

implies that

$${θ}^{B} = \frac{tan ( \frac{π}{16} ) + {θ}^{A}}{1 + tan ( \frac{π}{16} ) \cdot {θ}^{A}} = \frac{0.0034 + {θ}^{A}}{1 + 0.0034 \cdot {θ}^{A}} .$$

Now we can utilize the formula relating the value of a shape index to the ratio of the constituent principal curvature.

According to a preferred embodiment of the invention, techniques for curvature-adaptive sampling of a smooth surface will now be described in further detail.

Due to popularity of 2D FFT methods, it is common practice to sample a surface based on a fixed spatial step size. For smooth data, we know that a low order Taylor polynomial expansion can supply sample data to whatever a priori precision and at whatever spacing is acceptable. There is no need to store a large array when an algebraic expression can be evaluated on demand. Our method for curvature-based sampling is straightforward.
1. We are given a cloud of points. Using Hoppe's tangent-plane fitting procedure (Hoppe, pages 22-25), we loop through the input point cloud fitting tangent planes.
2. At each tangent plane, we determine if the parent point is a height field critical point. We record the set of all critical points {Cₖ}. We use the symbol T(Cₖ) to denote the tangent plane at Cₖ
3. At each critical point Cₖ, we define a neighborhood N(Cₖ) about Cₖ in the point cloud such that the tangent plane T(Cₖ) is a parameterization of the triangulation of the points in N(Cₖ). Abusing notation slightly, we use N(Cₖ) to denote the triangulation of the point cloud.
4. Using equations (4.7₁) and (4.7₂) we estimate both principal curvatures and the associated shape index on N(Cₖ).
5. Given a shape index increment, we apply the analysis developed in Section 8 to partition N(Cₖ) into shape index equivalence classes. We chose to seed the shape index equivalence classes with critical points so that there is the least ambiguity in the shape index assignment.
6. If the critical point neighborhoods do not cover completely the implicit surface, then search the remaining surface for regular points that have an unambiguous shape index interval assignment.
7. Bin the remaining unassigned sample points to new shape index equivalence classes.
8. Assign each shape index equivalence class to a distinct grid cell.
9. Done.

This algorithm uses just curvature information, since we apply it to the unorganized input point cloud. We can improve the N(Cₖ) partition if we know a priori that the shape identification procedure described above has been applied. Using the information generated during shape identification, we construct a low order. Taylor polynomial expansion that equals as a point set a shape index equivalence class. We begin with an estimate of the error that we expect if we expand the signed distance function (sdf) in a 1^{st} order gradient Taylor expansion plus quadratic remainder term. Let s(x, y) represent the sdf over an open neighborhood N(x₀, y₀) in the (x, y) plane.
Then the Taylor expansion for s in N(x₀, y₀) is

$$s ( x , y ) = s ( {x}_{0} , {y}_{0} ) + [ \frac{\partial s}{\partial x} ( {x}_{0} , {y}_{0} ) \cdot ( x - {x}_{0} ) + \frac{\partial s}{\partial y} ( {x}_{0} , {y}_{0} ) \cdot ( y - {y}_{0} ) ] + \frac{1}{2 !} [ \frac{{\partial }^{2} s}{\partial {x}^{2}} ( α x , α y ) \cdot {( x - {x}_{0} )}^{2} + \frac{{\partial }^{2} s}{\partial x \partial y} ( α x , α y ) \cdot [ ( x - {x}_{0} ) ( y - {y}_{0} ) ] + \frac{{\partial }^{2} s}{\partial {y}^{2}} ( α x , α y ) \cdot {( y - {y}_{0} )}^{2} ] ; α = α ( x , y ) and 0 < α < 1.$$

We translate s in the z-direction so that s(x₀,y₀)=0, eliminating the constant term. Now rotate the orthonormal basis defined by the tangent plane of the sdf at (x₀, y₀) plus the z-axis so that it coincides with the orthonormal basis formed the canonical co-ordinate system.

Notes:

a. Rotation in the (x,y) coordinate plane will align any pair of orthogonal vectors the coordinate plane axes.
b. Rotating the surface so that s(x₀, y₀) is a maximum causes ∇ s(x₀, y₀)=0.

Combining the translation and the rotation, the Taylor expansion is

$$s ( x , y ) = \frac{1}{2 !} [ \frac{{\partial }^{2} s}{\partial {x}^{2}} ( α x , α y ) \cdot {x}^{2} + \frac{{\partial }^{2} s}{\partial {y}^{2}} ( α x , α y ) \cdot {y}^{2} ] ; 0 < α < 1.$$

The coefficients inside the square brackets are the principal curvatures at (αx, αy). They can be computed from the mean and Gaussian curvature at (αx, αy).

$$H ( α x , αy ) = \frac{1}{2 !} [ \frac{{\partial }^{2} s}{\partial {x}^{2}} ( α x , α y ) + \frac{{\partial }^{2} s}{\partial {y}^{2}} ( α x , α y ) ]$$

$$K ( α x , α y ) = \frac{{\partial }^{2} s}{\partial {x}^{2}} ( α x , α y ) \cdot \frac{{\partial }^{2} s}{\partial {y}^{2}} ( α x , α y )$$

Using shape analysis, the true value of every term in the Taylor expansion is known. The Taylor disk records the first two terms in the expansion, the expansion point, the disk's radius of convergence, and the maximum error incurred on the convergence disk when a sample coordinate is approximated by just the constant and linear gradient terms. When an intersection curve is established, then the definition of the curve is attached. There is a separate attachment for every intersection curve.

The α parameter is interesting. Given the center of the Taylor disk, the disk radius, and polar angle increments then the α parameter describes the intersection as well as the principal curvatures along the intersection curve. (A more descriptive name for this parameter is “wireframe”.) This parameter determines the adequacy of the interpolating function in the 3D grid. In other words, the adequacy depends on the curvature of the parent surfaces along the intersection path.

We prepare the topological analysis of a shape-based surface by creating a manifold whose charts are point sets that correspond to shape index intervals. We call this a shape index manifold. We explained above how to construct the manifold's charts and how to estimate the differential properties of a chart. These tasks make sense with no external context, i.e., a background framework. We refer to properties that make sense in this self-contained context as “intrinsic”. Any property of a manifold that is not intrinsic is “extrinsic”. An example of an extrinsic attribute is the relationship between the boundaries of a surface and the boundaries of a shape index manifold.

An intrinsic boundary is one that remains a boundary under rigid motion. It is a Cartesian tensor by virtue of this definition. This boundary separates regions that are well approximated by patches taken from a surface of revolution. An extrinsic boundary is a boundary that owes its existence to the configuration of background surfaces. Should the background surfaces move then the shape of the intersection and indeed the very existence of the intersection can change. The choice of solver depends on the dataset assumptions. The Shapes® library does not provide recognition or interaction services pertaining to intrinsic boundaries. We agree that a characteristic of a sound approach to point set classification is a robust algorithm to compute the intersection of two extrinsic boundaries. But we go one step further and say that intersection in a region that is devoid of extrinsic structure can be still be quite complicated, if the intersection involves a non-empty subset of a non-differentiable interface that separates two shapes.

We seek a data structure that conveys a framework overview. We want it to contain the complete boundary representation for the framework plus a synopsis of the shape of every framework surface and curve. We envision using this data structure to reply to browser level framework data base queries when the caller does not want to open the framework with the standard geometry services toolkit.

We define a structural synopsis to be a Shapes/GQI topology graph (also known as a boundary-representation or “b-rep”) plus a shape index manifold description of every 2D node in the b-rep.

Preferably, a Reeb graph is used to describe a configuration's Morse critical points and homotopic skeleton. See, M. Hilaga, Y. Shinagawa, T. Komura, T. Kunii, Topology matching for full automatic similarity estimation of 3D, SIGGRAPH 2001, pg. 203-212, and Silvia Biasotti, Topological techniques for shape understanding, http://www.cg.tuwien.ac.at/studentwork/CESCG-2001/SBiasotti/. We recall the definition of a Reeb graph. Let M be a path-connected manifold and let f be a real-valued on M. Then the Reeb graph associated with (M, f) is a set of (M, f), R) equivalence classes that is defined by the relation (x,f(x))˜(y,f(y)) if and only if f(x)=f(y) and x, y are members of f⁻¹((f(x)). In practice, the nodes and arcs in a Reeb graph are determined from continuous sampling of homotopic identification of height field contours. Since the height field is a Morse function, we obtain information regarding each non-degenerate critical point and the cell to which the critical point is attached. The discussion of 2D parameterization herein summarizes the relevant facts from Morse Theory.

FIG. 19a shows the Reeb graph of a standard torus. FIG. 19b schematically illustrates a 2D cell suspension that is induced from the axes and planes of symmetry and critical point theory. The Reeb graph's nodes in this case are critical points on the torus, since the critical points are isolated and non-degenerate. The graph contains 4 nodes. The bottom and top nodes correspond to the height field minimum and maximum. These two points lie on an isoparametric curve of constant positive Gaussian curvature. The other two nodes correspond to the lower and upper saddle points. They too lie on an isoparametric curve, but this curve has constant negative Gaussian curvature. It is easy to see that the symmetry group of the torus leaves invariant the orbit of a saddle point as well as the orbit of the min/max. We remark that observing this invariant behavior is an easy way to discover symmetry transformations.

A Reeb graph describes homotopic equivalence. Reeb's representation has no concept of shape. The Reeb graph says nothing about Gaussian curvature or mean curvature or shape index. There is no mention of the two opposing curves of zero Gaussian curvature. Nor is there a description of the shape of the saddle point curve that bounds the interior void. Homotopic equivalence does not leave invariant 2D regions of constant shape index, so it is not possible to reason about symmetry orbits under Reeb equivalence.

Neither the Hilaga nor Biasotti references augment the Reeb graph substrate with curvature information, citing the natural instability of curvature estimation in noise. We agree that curvature estimation in a noisy environment is difficult, but we have above that it makes sense to treat a noisy surface as a smooth substrate that is contaminated with noise. We think of the representation of a noisy surface as a minimization problem in Lagrangian mechanics. The smooth approximant represents the kinetic energy in the decomposition. We define the curvature of the original surface to be that of the smoothed component of the original surface. The Riemann integral of the discrepancy between the smooth approximant and the original surface is a measure of the potential energy in the original surface. Noise introduces uncertainty into the curvature estimate. We compensate for this uncertainty by working with shape index intervals, rather than a point-specific value. We define a shape synopsis diagram (SSD) to a Shapes/GQI boundary representation where a 2D node is a shape index manifold.

We comment further that Hilaga reports the development of a similarity metric for a pair of triangulated surfaces S1 and S2. Their idea is to create a level of detail hierarchy for each surface. The authors summarize each level of detail by constructing a Reeb graph of the coarsened surface. Hilaga chooses the Reeb function to be the integral of geodesic distance measured at every vertex of S1 and S2. Hilaga approximates the integral using Dijkstra's Algorithm. Hilaga argues that this Reeb function is superior to a height field because the integral is insensitive to orientation.

We want to compare Hilaga's method to the method of the present invention. This is not easy. Hilaga works with triangulated surfaces rather than implicit surfaces. Consequently we must be careful regarding the meaning of the term “geodesic path”. On a smooth surface we can define a geodesic curve to be the straightest possible path or the shortest possible path, since the two characterizations coincide. On a triangulated surface they do not. As is common practice, we select “straightest possible” geodesics because an existence proof is available for “straightest possible” whereas none exists if instead we opt for “shortest possible” geodesics.

We restrict attention to a single surface of revolution S, because there exists a theorem that says that a parallel on S is a geodesic exactly when the tangent vector at any point on the surface is parallel to S's axis of symmetry. The symmetry group of S honors this constraint, so the geodesic is an orbit under the action of the symmetry group.

FIG. 20 is cross section of the torus shown in FIG. 19a. FIG. 20 shows the torus opened along a planar surface that joins the saddle point circular orbit and the min/max circular orbit.

In FIG. 20, we have overlaid the symmetry group orbits associated with critical points. We measure criticality against the standard height field Morse function, because geological data is naturally observed in depth. We free ourselves of orientation and pose limitations by working with the symmetry group orbits of critical points rather than the isolated critical points themselves.

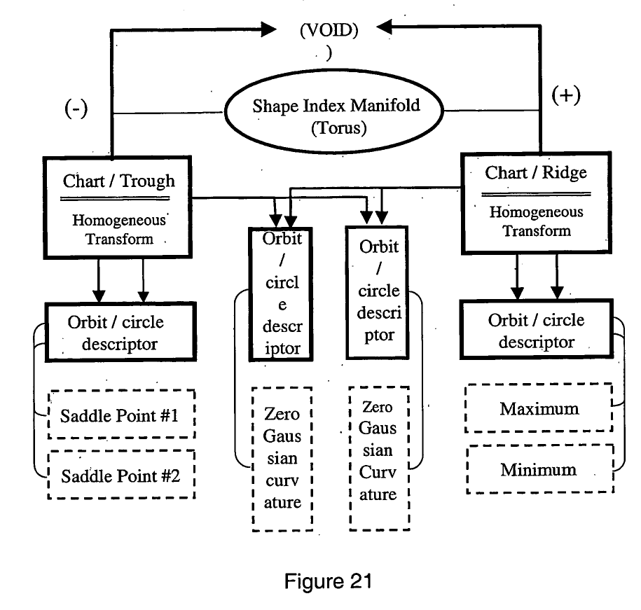

FIG. 21 is a schematic of the shape synopsis diagram (SSD) of the torus shown in FIG. 19a. The SSD reports locations in normal position coordinates and uses a homogeneous transformation to correctly position this data in model space. We also note that an SSD takes little storage beyond that already needed to instantiate the b-rep. We have placed details of the shape index manifold and shape index chart provided below.

Since an SSD augments the standard b-rep we attach a spatial frame to the b-rep node to reference the SSD. Since the top-level node in the SSD contains a database identifier, standard navigation methods can be used to locate the b-rep given the SSD. We call attention to the arrow notation in the SSD. We use an arrow to define the correspondence of 1D chart boundaries to 2D charts. The arrow that is attached to the concave chart signifies that the chart does not bound a sub-volume along its outside. Similar remarks pertain to the convex chart.

The Reeb graph of a cyclide is identical to the Reeb graph of a torus, as expected since the standard Reeb graph does not consider shape. The difference between a cyclide SSD and a torus SSD is the absence of circular orbits connecting critical points. That is, all of the height field critical points for a cyclide are isolated and are fixed by the cyclide's back to front reflection operator.

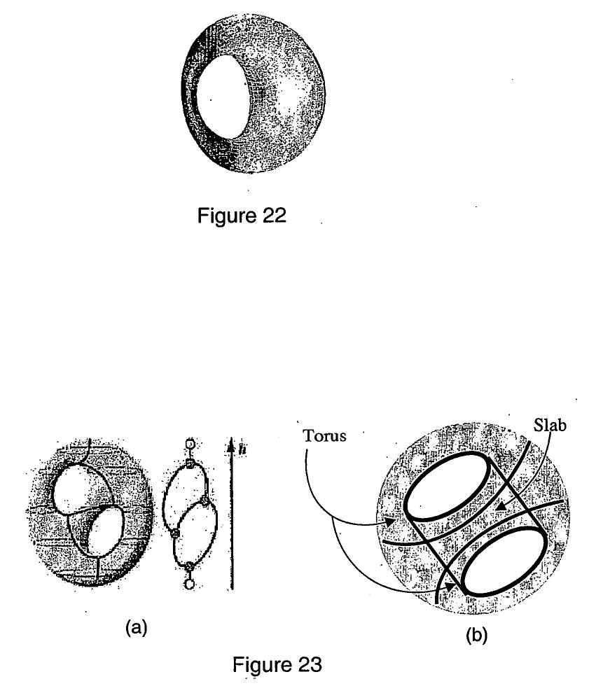

FIG. 22 is a cyclide that is shaded according to Gaussian and mean curvature.

Next we construct the SSD for a 2-torus. FIG. 23a is a bi-torus with its associated REEB diagram. FIG. 23b is the visual representation of the bi-torus shape synopsis diagram. A shape index manifold is a patchwork, with each patch taken from a surface of revolution. So it makes sense to display the surfaces of revolution, where each surface is decorated with the bounding curves that define the patch selection. On the bi-torus's SSD there are two thin circular arcs plus the outer circle identify the two toroidal components in the bi-torus. We attached the “slab” label to the connective material between the two tori, because-we perceive the top of the bi-torus to be flat, i.e., its Gaussian curvature is zero. The slab's internal boundary joins the upper and lower parabolic curves on both tori. We have suppressed the 1D orbits and critical point assignments to keep the diagram readable. The bi-torus is a genus 2 sphere, so there is 1 minimum and 1 maximum. Since the tori are tilted, the height field does not see the any critical points along either saddle point orbit. Finally, the interior surfaces of the slab are concave (hyperbolic) in order to conform to the torus's exterior convex surface.

The differences between an SSD and a Reeb graph are very clear. The use of homotopic identification means that the Reeb graph cannot distinguish homotopic figures that have significantly different curvature, e.g., a convex figure from a convex figure. Therefore shape index analysis is meaningless in the context of a Reeb graph. We conclude that although we can map a Reeb graph into an SSD, a Reeb graph cannot support a shape index manifold.

According to a preferred embodiment of the invention; an efficient hierarchical surface representation will now be described. We represent an implicit surface's signed distance function in a narrow band octree encoding of a regularly spaced Cartesian grid. We discuss herein how curvature and shape analysis of the implicit surface simplify the octree as a data structure. Smoothing or editing in general is likely to change a prior shape analysis, so we will also describe herein an adjunct shape index representation that enables fast updating of the octree's information archive.
1. We begin by computing the shape index on the implicit surface at the finest resolution in the octree.
2. We partition the shape index data into equivalence classes.
   a. We find the finest resolution octants that contain the surface's height field critical points.
   b. We define, the following shape index relation on the octant corners that were located in the previous step.
   c. We say that two octant corners are related when that their respective shape index values are contained in the same Cantzler sub division of the fundamental space [−1.0, +1.0] and that both values are bounded away from both ends of the Cantzler subdivision.
   d. We make a second pass over every equivalence class of octree nodes that contains less than a threshold number of samples. Let ν be such a node and suppose that ν is on the frontier of shape index equivalence classes χ1 and χ2.
   e. If χ1 and χ2 are approximated by a single elementary shape instance, then we will assign the node ν to either χ1 or χ2.
   f. If χ1 and χ2 are not approximated by a single elementary shape instance, then we assign ν to χj if the error in the elementary shape approximation is less than a threshold
3. We introduce the shape index information to the coarser levels of the octree.
   a. We say that a low-resolution octant is stable if there exists an elementary shape representation for all highest resolution level nodes that are controlled by the coarse level octant.
   b. We record stability status. If a low-resolution node is stable, then it will use the elementary shape's algebraic evaluators for signed distance, mean and Gaussian curvature, etc.
   c. We recognize that a stable low-resolution octree node ν has the same shape resolution as ν's finest resolution level components. If we want a truly coarser approximation, then we develop a separate family of elementary shapes for each resolution level in the octree.
4. We prune the stable regions of the octree.
   a. Given an octant Q at level L such that its leaf level resolution is part of an ideal elementary shape.
   b. We set a status bit in Q that says it coarsely resolves part of an ideal shape.
   c. Prune the branch of the octree rooted at Q.
   d. If Q does not coarsely resolve part of an ideal, then we keep the branch rooted at Q. Furthermore, we may need to use the leaf-level interpolator to estimate curvature.

The situation most favorable to this algorithm is when the root surface S* contains a large stable region. This can happen if the leaf-level surface S contains a large region of zero Gaussian curvature, in which case the shape index for the region is ½ or −½. A Another favorable situation is that both the mean curvature and Gaussian curvature are constant, e.g., a sphere, so that the shape index is again a constant.

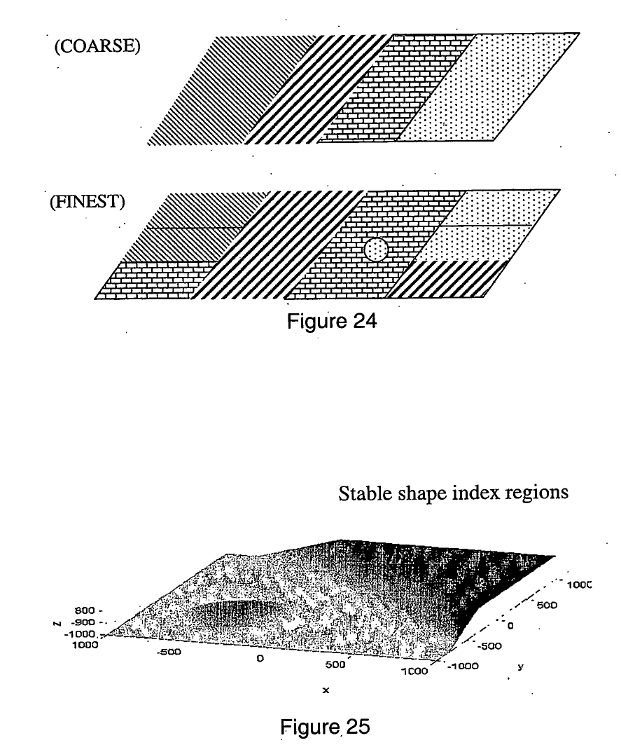

FIG. 24 is a diagram of the octree with a coarse level and leaf level shape index relationship indicated. Consistent texture-coding between corresponding regions indicates a stable shape index region.

We consider two examples. The FIG. 25 is a diagram shows part of the French model. A single octree leaf defines each plateau. The hemispherical depression has constant mean curvature and constant Gaussian curvature, so in both regions only one octree leaf is needed.

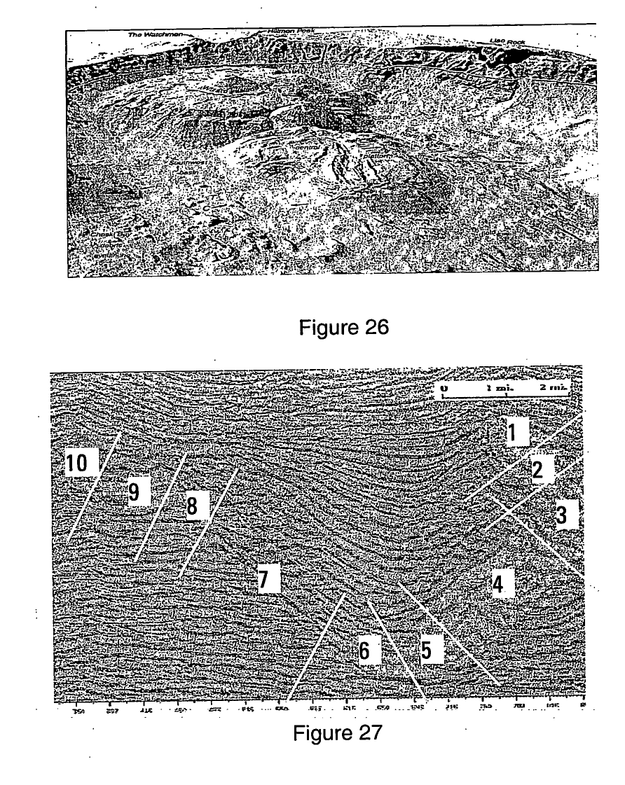

FIG. 26 is an image of the topography of Crater Lake, Oreg. FIG. 26 shows two large plateaus in the Southwest part of the lake basin. There are large flat regions of the lakebed, so this algorithm will represent these regions economically. The small elevation bumps on the lakebed will be enclosed in extruded cylinders.

We anticipate that the algorithm will perform well on the large trimmed conical plateau in the rear.

According to a preferred embodiment of the invention, an implicit surface shape identification technique will be described. In particular we show how to uniformly approximate an implicit surface by a patchwork of smooth shapes, where each shape is a section of a surface of revolution. The implicit surface is not required to be smooth. We say that the volume between the given implicit surface and the patchwork of smooth shapes measures the misfit of the approximation. We improve the uniform approximation by reducing the misfit. We reduce the misfit by approximating the volume as a Riemann sum of generalized prisms.

Shape identification provides a much higher density of information. FIG. 27 shows a salt weld in the Gulf of Mexico. See, M. Hodgkins, M. O'Brien, Salt sill deformation and its implications for subsalt exploration, The Leading Edge, August 1994, pg. 849-851. We enumerate the shapes that collectively represent this complicated geobody.

The shape legend for this image is as follows.

| | |
|---|---|
| 1 | Paraboloid cap |
| 2 | Cylinder |
| 3 | Toroidal sector |
| 4 | Barrel |
| 5 | Conical sector |
| 6 | Toroidal sector |
| 7 | Barrel |
| 8 | Conical sector |
| 9 | Toroidal sector |
| 10 | Cone |

Now we specify the shape identification algorithm.

Notation
S A noisy implicit surface.
S* A smoothed version of S.
G A 3D regularly spaced grid
C A grid cell in G with corners {c0 . . . c₇}.
σ The signed distance function defined on C such σ⁻¹(0)=S∩C≠0.
τ Tri-linear interpolation associated with grid cell C that approximates the signed distance function σ on C.
σ* The symmetry group of σ.

Shape Identification Algorithm
1. We are given a 3D rectangular or rectilinear grid G that contains an implicit surface S.
2. Construct a smooth surface S* from S, eliminating noise, but not low frequency intrinsic shape.
3. Sample S* such that there exists a sample at each entry and exit point on each grid cell face in G. We know how to do this, since we know the nature of a smooth shape that tri-linear interpolation can represent.
4. For each S* sample point estimate the mean and Gaussian curvature.
5. Compute the shape index at every S* sample point.
6. Mark those samples that are close to the center of a Cantzler shape index interval.
7. Mark those grid cell samples that are height field critical points, i.e., minima, maxima, and saddle points. (We know that these occur at grid cell corners only.)

We identify shapes on S*.
8. For each S* critical point select grid cells attached to the critical point that have consistent mean curvature, Gaussian curvature, and shape index estimators at all sample points in the grid cell These grid cell sets define the initial equivalence classes.
9. We want to define a shape from the region of S* inside the grid cell equivalence class. We check that each admitted grid cell's tri-linear interpolant has the same symmetry group. If there is no common symmetry group, then we subdivide the equivalence class into subclasses that do have a shared symmetry group.
10. Using the shape index data and the symmetry group, identify a surface of revolution that best fits the curvature and unit normal vector field data.

Let C be a grid cell that is unassigned to a grid cell equivalence class, but is adjacent to a grid cell that has been assigned to a grid cell equivalence class. We want a condition to test for admission to the equivalence class.
11. There are two categories of grid cells in an equivalence class. A member grid cell is either “shapely” or is a “misfit”.
12. In order for the candidate grid cell to be admitted as “shapely”, it must satisfy the following conditions.
   a. Its tri-linear interpolation function has the same symmetry group as all other shapely grid cell members.
   b. If a shapely grid cell in the equivalence class shares a grid cell face with the candidate grid cell, then they share a smooth boundary across the grid cell face.
   c. We re-compute the shape parameter vector and re-test all grid cells in the equivalence class. No “misfit” grid cell is allowed to exceed the misfit tolerance and no shapely grid cell can become a misfit.
13. Test if the candidate grid cell is shapely.
14. If not, then test if the candidate can be considered a “misfit”.
   a. A misfit must be less than some threshold and no point on the surface sample in the candidate grid cell can be further from the ideal shape than some other threshold.
15. If the misfit is acceptably small, then we mark the grid cell as a “misfit” and admit the grid cell.

We specify a misfit reduction algorithm later in this part of the description.

It may be that some grid cells have not been assigned to an equivalence class. These grid cells are not associated with a shape that has a critical point in the smoothed implicit surface S*.
16. Form a new equivalence class by finding connected sets of grid cells where the individual grid cell tri-linear interpolation functions have the same symmetry group and whose shape index samples lie in the same Cantzler shape index interval.

It may be that some grid cells can be assigned to more than one equivalence class. If we have a choice, then we assign the candidate to the class that accepts the candidate as shapely.

It may be that some grid cells have not been unassigned to an existing equivalence class. Since S* is smooth, we know that noise is not a contributing factor. Instead, we have uncovered a set of grid cells that represent a rapid change in shape. When we encounter a grid cell of this type, then we deform the shape in the grid cell to conform to any adjacent grid cell and assign it to the equivalence class that forces the least amount of deformation.

Two equivalence class shapes may fail to connect in a region where they should. When this happens, we deform the respective shape in those boundary grid cells until they match the tri-linear interpolation function in each grid cell.

We now discuss the interface between two grid cell equivalence classes. If a grid cell face separates the two equivalence classes, then we call the interface “sharp”, otherwise the interface is “diffuse”. If the interface is “sharp”, then there exists a 1D boundary separating the two shapes. We compute this boundary by equating the two quadratic surface expressions and solving. This is not always smooth, so it will be necessary to blend a narrow region on each side of the intersection curve. If the interface is diffuse, then we have a 2D region of overlap between the two shapes in which the smoothing can be naturally accommodated. We fit a shape to the overlap. We close this topic by checking this analysis against two adjacent grid cells that have different conic section fibre bundle shape approximations. We conclude that the analysis is valid, since tri-linear interpolation is continuously differentiable on the grid cell face that separates the two adjacent grid cells.

Now we overlay the patchwork shape on top of the original implicit surface S and look for chances to reduce the misfit. We will do this by approximating the volume as a 3D Riemann integral. Our misfit reduction procedure is as follows.

Misfit Reduction Algorithm
1. We project the noisy implicit surface onto the patchwork smooth surface. We identify connected regions of the implicit surface that are responsible for significant misfit and try to reduce these regions first.
2. We anticipate multiple misfit regions associated to each smooth shape. The most complicated element in a misfit description is the representation of the outermost 1D boundary of the misfit. We use the outermost 1D boundary to define a Riemann sum approximation to the misfit. Consequently, we will ignore (initially, at least) low amplitude but high frequency nearby features.
3. Define height field (relative to the smooth approximant) contours at each critical point in the noisy implicit surface. Project these contours onto the smooth approximant.
4. Smooth the set of projected contours. For each contour in the parameterization we identify the critical points on that contour. We triangulate the annular region bounded between consecutive contours.
5. Now we fit a frustum-like collar to the base of the region where the misfit attaches to the background.
6. The cumulative shape resembles a telescope, hence the name “telescopic deformation”. The process accommodates tendril-like shapes, in the sense that surfaces can recursively support branches off other earlier branches.

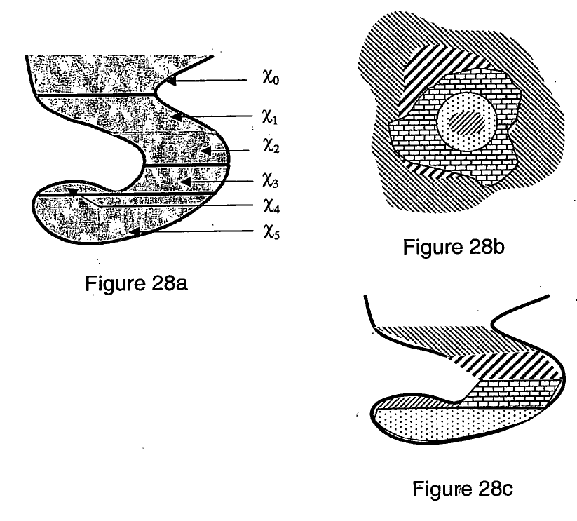

FIGS. 28a-c illustrate an example of the misfit reduction process. Suppose that we want to reduce the misfit in approximating a tendril shape by a plane, see FIG. 28a. We subdivide the tendril using height field planes that approximately set to the tendril's critical points.

We have generated a sequence of truncated collars that reduce the misfit. We are not done, however, since this approximation is not differentiable at any point on a collar ring separating two truncated cones. We remedy this deficiency by replacing a thin swath about the ring with a thin swath about the equator of a sphere.

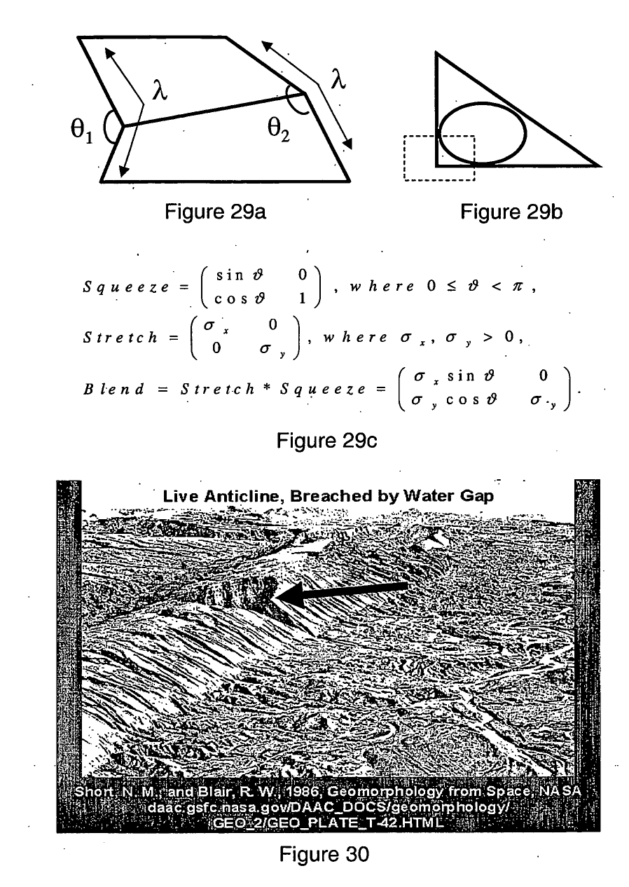

FIGS. 29a-c illustrates an example of blending a non-differentiable join of two collars. The idea is to map given instance (FIG. 29a) to the one situation that we understand how to fix (FIG. 29b). The one situation that we understand how to fix is an isosceles right triangle with an inscribed circle such that the center of the circle is the centroid of the triangle. We apply the linear transformation shown in FIG. 29c to the isosceles right triangle in panel shown in FIG. 29b to the exterior and interior triangles—corresponding to θ₁ and θ₂, respectively—in FIG. 29a.

The misfit reduction procedure is as follows.
1. We construct height field contours on the noisy surface S. Remember that the height field is taken normal to the smooth shape approximation S*.
2. Working top down, we project each contour to S*. It is possible that the projection of successive contours cross.
3. We approximate each contour projection in two steps. First we locate all 1D critical points—minima, maxima, and inflection points. Second we fit a smooth approximation to each section of the projected contour; where a section is delimited by critical points.
4. We triangulate the interior of each projected contour, and then construct tetrahedra using consecutive contours.
5. We approximate the cap/cup corresponding to the innermost ring of the bull's eye with the ring's closure in the plane.

We next consider how to describe a branching structure of hills that separate a region into multiple valleys. FIG. 30 shows as a geological example a water breach as indicated by the white arrow.

Here is a compact description of this branching structure.
1. Find the ridge edge in the branching structure. The ridge edge is a connected (therefore degenerate) set of critical points.
2. We assume that as typical cross section is a conic section, e.g., a parabola, an ellipse, etc.
3. We allow for stretching and contracting of the cross section. We call a region over which the typical cross section stretches or contracts a “transition zone”. We provide linear interpolation between the start and stop position cross sections.
4. We anticipate a valley that runs perpendicularly to the ridge edge. For the case of a branching structure, we treat a valley of this type as a misfit. The following NASA aerial reconnaissance image contains active breaches in the ridge structure.

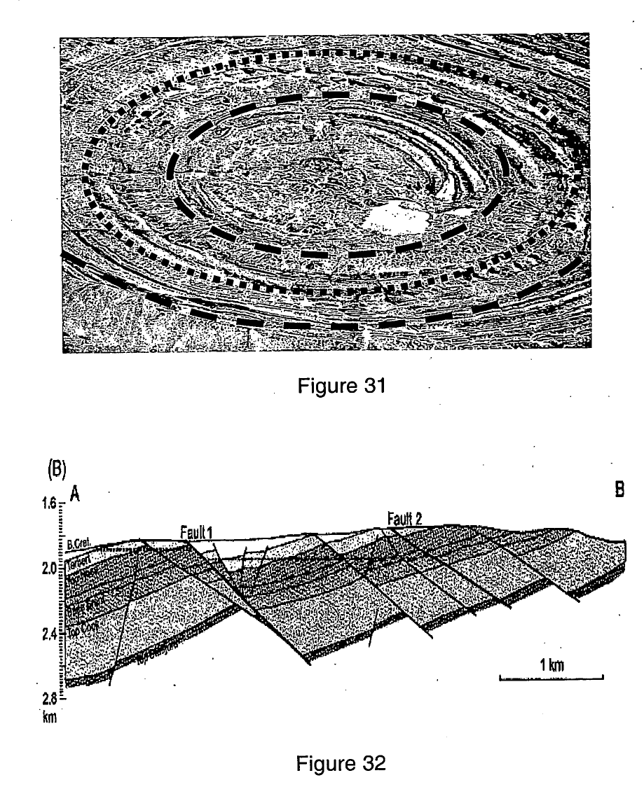

We consider a more challenging example. FIG. 31 is a NASA Shuttle Mission photograph of the Richat Structure in Mauritania. NASA believes that most likely explanation of the origin of this structure is that it is uplifted rock sculpted by erosion. NASA also says that there is no widely accepted theory that explains why the Richat Structure is nearly circular.

The dominant shape in the Richat Structure is a nested sequence of toroidal structures. Because of erosion, some of the toroidal structures exist as sections of a torus only. Ecker argues on pg. 4-5 of his lecture notes that a torus satisfies mean curvature flow with respect to its mean curvature. This flow is singular, in the sense that in finite time the circular cross section shrinks to a point and hence the torus shrinks to a circle. This is a second example of the fact that mcf evolution need not preserve the dimension of a shape. (The other example is an uncapped cylinder whose radius r(t) is given by the formula
r(t)=\sqrt{r²(0)−2t}, provided that

$$t ∈ ( 0 , \frac{{r}^{2} ( 0 )}{2} ) .$$

In finite time the uncapped cylinder collapses to its axis of symmetry.

With respect to known techniques, Rouby et al. describe a parameterization algorithm for triangulated surfaces. See, D. Rouby, H. Xiao, J. Suppe, 3D Restoration of Completely Folded and Faulted Surfaces Using Multiple Unfolding Mechanisms, AAPG Bulletin 84(6), June 2000, pg. 805-829. This method involves projecting the triangulation onto the (x,y) co-ordinate plane. It is not clear how to compensate for triangles that have a near singular projection. Also, the projection of multiple triangles onto a common plane can lead to a complicated overlapping and slivers. These are the sort of numerical instabilities that we want to avoid and which this algorithm does avoid.

A description will now be give for 3D conformal grid generation and reconstruction of shape from disconnected pieces, according to the invention.

Shape identification improves the performance of our incremental 3D conformal grid generator. Given a sub-volume V with boundary ∂V=S, we uniformly approximate S as a collection of trimmed ideal elementary shapes {Eₘ}. Then we enclose S in a tight sequence of rectangular prisms {Pₖ} such that the “vertical” edges of the prism are normal to the ideal elementary shape approximants.

We generate a 3D conformal grid in 3 parts.

1. ∂Pₖ∩S, which is the part between the prism faces and the measured surface S.
2. The bounding box Bₘ of each trimmed ideal elementary shape Eₘ.
3. A prism P*⊂V such that P*∩Bₘ=0

We use a proportional spacing correlation scheme to grid part #1. In part #2 we use Em's parametric expression for normals to grid Bm. In part #3 we grid P* in the obvious way. The incremental nature of the procedure follows from the subdivision of the grid into regions associated with the prismatic enclosure of S and the uniform approximation by trimmed ideal elementary shapes.

FIG. 32 shows a conformal grid induced from a proportionally spaced correlation scheme. We use a proportional spacing correlation scheme to define the grid iso-surfaces. Here is an ideal application of this mechanism (This is an idealization of a cross section through the Gullfaks field.). We see that the sub-blocks have approximately the same z-direction thickness. It is irrelevant how the horizontal extents correspond. In other words, we can generate either a regular spacing grid or an irregular spacing grid. We remark that a compromise such as a “tartan grid” (also known as a rectilinear grid) is more memory efficient than a regular grid but still has a convenient algebraic lookup function.

We observe that a correlation scheme implements a cheap form of mean curvature flow and if generated independently of a parameterization, then the conformal grid is a roundabout way to also generate a parameterization.

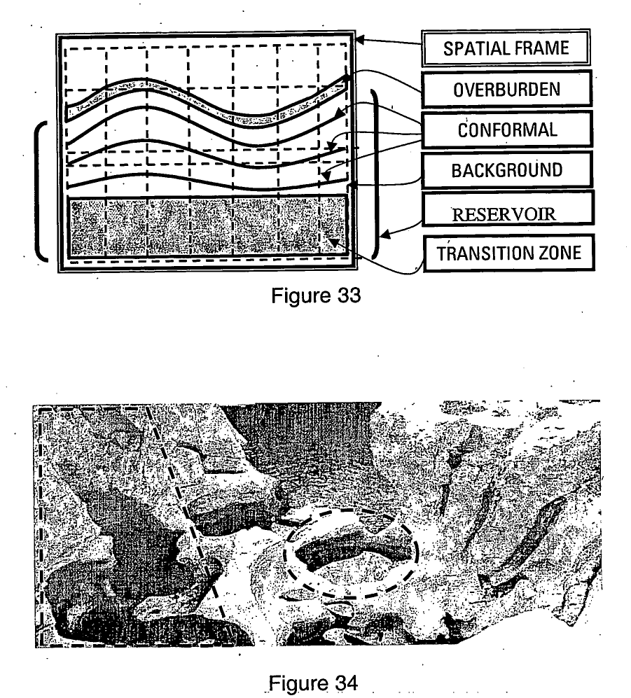

We conclude this part of the description with a discussion of a way to convert an existing 3D Cartesian grid to a conformal grid. FIG. 33 illustrates a non-conformal. 3D Cartesian grid. As is well known, it is non-trivial to trim grid cells that cross volume boundaries. Here the background grid shown in dashed lines, crosses the overburden. It is clear in this diagram that the background grid cells do not conform to lithological boundaries.

We remedy these deficiencies in the following way.
1. We attach the volume of interest to a spatial frame.
2. We conformally grid the volume that lay between the overburden and the reservoir.
3. For best results we want a transition zone from a Cartesian grid to the conformal grid, preventing reverberation in the grid across lithological boundaries.

Forensic reconstruction will now be discusses. Suppose that an application identifies a set of disconnected 2D patches and would like to construct a surface from the patch set. We show how mean curvature flow enables us to construct such a surface—hence the sub-title for this discussion. This technique will be seen to be similar in execution to grid generation, which is why we discuss it here.

Suppose that we have a collection of 2D patches in R³. We assume that all of the patches are oriented in a consistent manner, which must be the case if all of the patches are taken from a common surface. We construct the solution using patches or parts of patches that have a common Gaussian curvature signum. We do not insist that the Gaussian curvature signum be constant across the patch point set. However, if it is not constant, then we use only those patches and parts of patches that have the same signum to construct a surface. This procedure can create holes in the surface. We fill in these holes with the remainder of patches that were used only partially. Some patches with the opposite signum may not fill in holes, but instead form folds in the surface. We construct a second surface from these patch point sets and union the two parts together.

We remark that the following algorithm is applicable to the task of sewing together parts of the bounding surface of a geobody, e.g., a salt body.

Our method is as follows.

1. We assume that the velocity of the flow equals 1, so that a time interval is equal to a distance.
2. For each patch or region of a patch R that has (+) signum Gaussian curvature, we define a uniformly expanding mean curvature flow with initial condition equal to R.
3. These patches are taken from a common surface, so we sample each flow at the same time step increments.
4. We stop a particular flow when it intersects another flow pattern.
5. Eventually each flow intersects a different flow.
6. It may be that the confluence of two flows is not differentiable. If this happens, then we define a flow to smooth the sharp angle. Alternatively, we can smooth the sharp angle using the Squeeze operator defined in the Misfit Reduction algorithm.

If a formation contains a tunnel, then we may wish to reverse the dissolution process, i.e., fill in the tunnel. In this situation we will approximate the tunnel as a collection of uncapped cylindrical and toroidal sections. Ecker's lecture notes show that mean curvature flow applied to an uncapped cylinder will shrink the 3D surface onto its 1D axis of symmetry in finite time. Smocyzk has obtained a comparable result for a torus. His result shows that a torus collapses under mean curvature flow to its inner parabolic circle in finite time. We conclude that when applied to a tunnel, mean curvature flow will collapse the tunnel to a curve in finite time.

FIG. 34 is an image of the Devil's Potholes, South Africa. We can identify two different kinds of pothole formations in this image. The circled pothole on the right is well described as a cylinder. We can collapse it to its axis of symmetry—which is a line—under mean curvature flow. The pothole on the left is more complex. The top of this region is a curved throat, which is followed by a sharp edged cone. Finally there is a toroidal section that is turning away from the viewer. We know that each section will collapse to a singular edge in a finite amount of time. Taking the longest time interval needed to collapse a section of this structure, we guarantee that the entire pothole will collapse to a polygonal path.

We now discuss a related problem. Given an image of a layered sequence, suppose that an unconformity. The unconformity will erase everything in the image that is above the unconformity. How good a reconstruction of the eroded interface can I achieve, given just the migrated image. As an example, we return to the diagram of a cross section of a shallow sequence in Turkmanistan shown in FIG. 3. We are interested in the guess of what the missing section of the layer looks like.

Our algorithm assumes that the formation satisfies the following assumptions.
1. There exists a reference layer such that the visible part of the sequence is well approximated by a single reference surface adaptively sampled correlation scheme. In the above schematic, the vertically striped layer R is the reference layer.
2. We reconstruct the eroded region of a layer by evolving the reference interface under mean curvature flow until the front joins the unconformity. In the above schematic, the reconstructed interfaces are shown as dotted outlines above the unconformity.

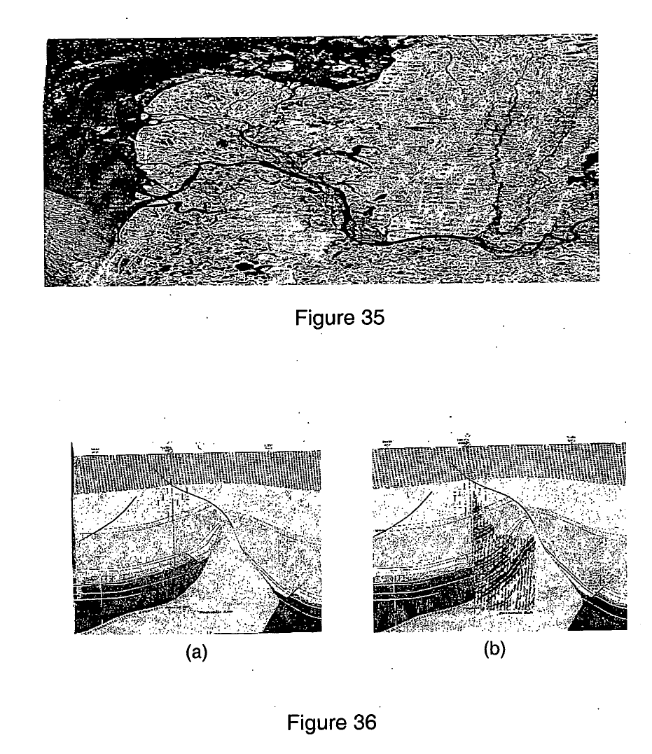

While it may not be obvious from FIG. 3, conformal grid generation is a very short time solution to mean curvature flow. In other words, if erosion had not been imposed then we would recognize the conformal grid generation in the framework close to the reference surface and flattening further away. As an illustration, we consider FIG. 35, which is a NASA LANDSAT image of the Yukon River delta (NASA Geomorphology plate D-9). We focus on the boundary cracks that subdivide the rounded joint at the left top of the image. These boundaries delimit curvature flow regions that collectively form the bend in the deltaic mass. It has been proposed to use a diffusive process. See, J. Davis, S. Marschner, M. Garr, M. Levoy, Filling holes in complex surfaces using volumetric diffusion, First International Symposium on 3D Data Processing, Visualization, and Transmission, Padua, Italy, Jun. 19-21, 2002. This reference does not make use of curvature information in the algorithm used. Furthermore, the reference does not deal with closing 3D voids such as tunnel closure.

We have discussed how to construct a patchwork covering of an implicit surface from first order Taylor polynomials. The error term is quadratic with coefficients that are the principal curvatures defined at a point that is somewhere within the circle of convergence about the expansion point. The radius of the circle is chosen so that the error term is smaller than a user-defined tolerance. The error estimate is not sharp, because it is not obvious where to evaluate the error term's principal curvature values, i.e., what is the definition of α. Since this error estimate is not sharp, we supplement the Taylor representation with a fast technique to evaluate α.

From curvature analysis we derive a representation of a surface as a connected sum of trimmed elementary shape. Some examples of elementary shapes are (sections of) an ellipsoid, hyperboloid, cyclide, and a prism. An elementary shape has algebraic expressions for mean curvature and Gaussian curvature. These expressions can be substituted into the quadratic formula to generate an algebraic expression for principal curvature. Unfortunately the resulting expression is often so complex algebraically that a symbolic algebra package such as Mathematica® must be used for any manipulation other than simple evaluation. This is awkward in an Engineering environment, so a low order Taylor series approximation is preferable.

Here is an intersection algorithm for implicit surfaces. This algorithm assumes that every surface's signed distance function has been defined on a shared grid.

Notation

S₁ implicit surface #1
σ₁ a point on S₁
τ₁ parametric definition for σ₁
S₂ implicit surface #2
σ₂ a point on E₂
τ₂ parametric definition for σ₂.
G a shared 3D grid
C a grid cell in G such that C∩S1∩S2≠0
cⱼ a point in C∩S₁∩S₂.
σ₁₂ a point in C∩S₁∩S₂.
   Intersection Algorithm
1. Find all grid cells {Cₖ} that surface Sⱼ intersects. A grid cell is involved if and only if the signed distance function is not constant at all grid cell corners.
2. In this algorithm we want to work with surface patches that project invertibly onto a face of grid cell. We subdivide the part of a surface contained in a grid cell into the desired patchwork by checking the surface normal field restricted to the grid cell. We place, a point on the surface in a patch exactly when the unit normal at the point is within tolerance of being parallel to all other surface points that are already assigned to the patch.
   For each S₁ patch find all S₂ patches such that their corresponding sdf patterns do not rule out intersection. For clarity we assume that each surface contains exactly one such patch.
   Loop$0:
3. Let c₀ be the midpoint of the line segment λ₀ connecting two faces of C such that the signum of the sdf for S₁ on one of the connected faces is different from that on the other.
4. Let j=0.
   Loop$1:
5. Project cⱼ onto S₁ and S₂, respectively.
6. Label the projection s₁ⱼ and s₂ⱼ, respectively.
7. Either s₁ⱼ=s₂ⱼ or not.
8. If s₁ⱼ=s₂ⱼ, then go to Label$2.
9. If s₁ⱼ≠s₂ⱼ, then construct the line segment λⱼ₊₁ in Cₖ connecting s₁ⱼ to s₂ⱼ.
10. Let cⱼ₊₁ be the midpoint of λⱼ₊₁.
11. It might be the case that cⱼ≈cⱼ₊₁. We expect to see this when a very thin hyperbolic neck is contained in the same cell as Cₖ.
12. If cⱼ≈cⱼ₊₁, then we want to jump away from this hopeless local minimum. We do this by comparing the signum of the sdf for s₁ⱼ and the signum of the sdf for s₂ⱼ to Signum of sdf obtained on the grid cell faces joined by the line segment λ₀. Moving in the direction that differs from the current values, jump to the midpoint along λ₀.
13. Increment j and return to Loop$1.
   Label$2:
   We use a Newton algorithm to find another point of intersection
   Loop$3:
14. Let (x₁₂, y₁₂) be a point of intersection for S₁ and S₂ in C and suppose that (x₁₂*, y₁₂*) is another point of intersection in C. Expanding each surface in a 1^{st} order Taylor series about (x₁₂, y₁₂), we have
   S₁(x₁₂*,y₁₂*)=S₁(x₁₂,y₁₂)+∇S₁(x₁₂,y₁₂)·(x₁₂−x₁₂*,y₁₂−y₁₂*)
   S₂(x₁₂*,y₁₂*)=S₂(x₁₂,y₁₂)+∇S₂(x₁₂,y₁₂)·(x₁₂−x₁₂*,y₁₂−y₁₂*)
15. Subtracting, we have 2 linear equations in two unknowns. Solve for the non-trivial solution
   0=∇(S₂−S₁)(x₁₂,y₁₂)·(x₁₂−x₁₂*,y₁₂−y₁₂*)
16. Return to Loop$3 until (x₁₂*, y₁₂*) is acceptably close to being another point of intersection in C.
17. We compute the intersection curve between (x₁₂, y₁₂) and (x₁₂*, y₁₂*) by repeating the midpoint subdivision algorithm in Loop$2.
18. Return to Loop$3 and repeat the 1^{st} order Taylor series algorithm in Loop$2 on both ends (x₁₂,y₁₂) and (x₁₂*,y₁₂*) until the curve crosses the faces of Cₖ.
19. Return to Loop$3 and continue processing grid cells in {Cₖ} until exhaustion.
   Visualization of an intersection curve is as follows.
1. Project the intersection curve onto the internal cylindrical parameter space.
2. Facet the cylinder using a constrained Delaunay algorithm.
3. Invert the mapping, projecting the triangulation of the region enclosing the “flattened” intersection curve to the parent implicit surface.

We have described a curvature-adaptive method for placing sample points on a surface and generating a narrow band octree from them. Now we discuss how spatial frames can be used to implement an efficient update mechanism. For details of the reappearance of SIGMA's hybrid grid-mesh concept, refer to U.S. patent application Ser. No. 09/163,075, incorporated herein by reference.

Each geological feature has its own octree which overlays part of the background octree. An overlay can cover a strictly smaller region of the background, and this small region can be sampled differently (adaptively) from the background. The sampling can be adapted to the complexity of the framework region that the overlay encloses. The overlay changes as the framework region changes. A separate spatial frame is assigned to control each octree overlay. Overlays are loaded on demand. Within a spatial frame the sampling can be adjusted in an adaptive manner. A frame boundary sample node can be part of multiple octree overlay. An entity that is outside a particular spatial frame learns about the frame's enclosed shape by interrogating the enclosing spatial frame. Given an octree identifier and a location inside or on the boundary of the octree's enclosing frame, the local cpt returns the cpt and sdf for the remote octree overlay. Adjacent frames might support a different set of and number of framework surfaces.

Given a region of interest, we associate to each spatial frame the point set that the frame contains. We represent the set of spatial frames associated with a region of interest as a directed acyclic graph. Two parent frames that partially overlap will be represented in the graph as nodes that point to a common descendant. Thus spatial frames constitute a topology graph.

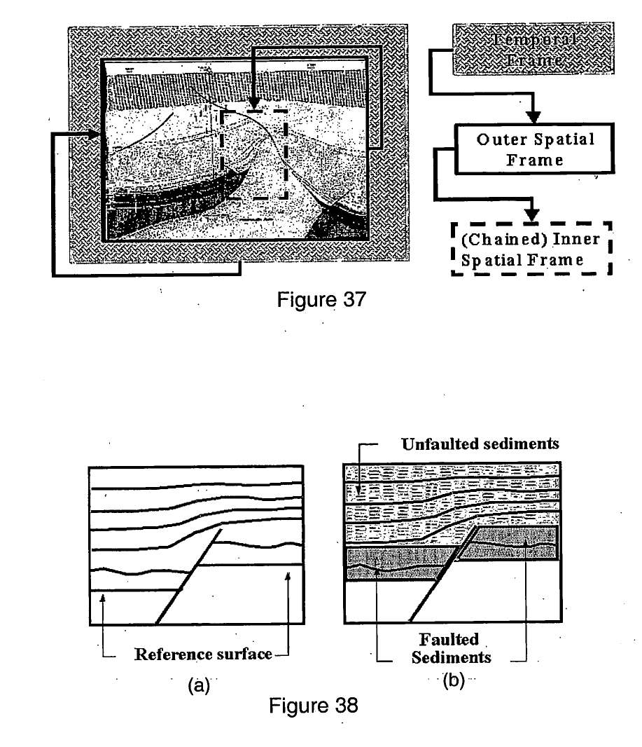

As an example, a vsp was acquired over part of the Zechstein Salt formation. FIGS. 36a and 36b show, for reference, the background Zechstein Salt and the region in the Zechstein where the vsp was acquired. FIG. 37 show the frame graph that ties the vsp region of interest to the Zechstein Salt background. We use the inner frame to outer frame relationship to express “A is a boundary of B” and “A is logically part of B”. In GQI terminology a spatial frame as defined herein is equivalent to a gqi_Frame_t. We have extended this functionality two ways. First, we maintain logical containment, i.e., feature relationships. Second, we allow mixing space and time frames.

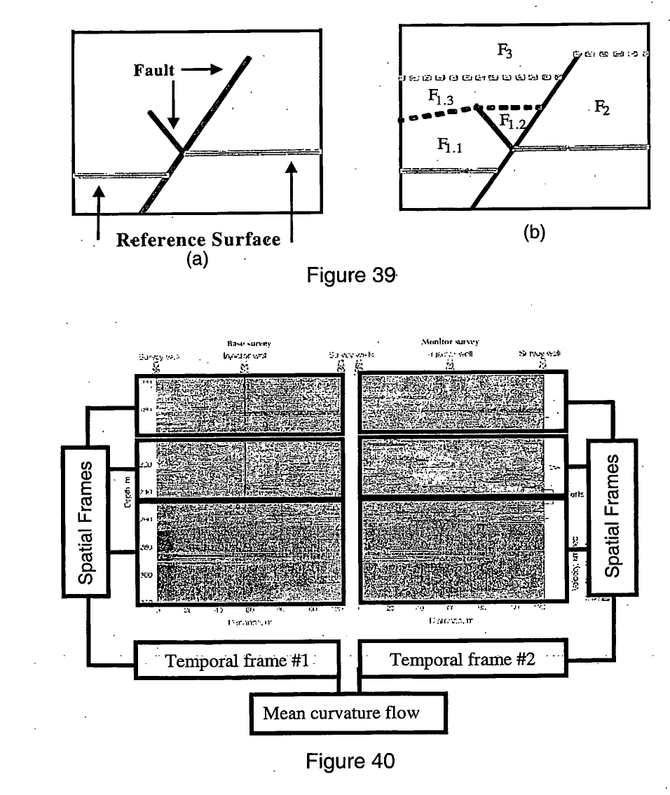

Spatial frames are useful in subdividing a faulted region to match regions subject to different physics. For example, FIGS. 38a, 38b, 39a and 39b illustrate the separation of faulted sediments from unfaulted sediments. FIGS. 38a and 38b show the case of a sequence of sediments such that some but not all of the sediments have been faulted, and a simple normal fault is involved. FIGS. 39a and 39b show the case of a fault network where some of the faults in the network emanate from other faults. FIG. 39b shows that the unique final configuration of spatial frames that partition the volumes shown in FIG. 39a. Using mathematical induction on the number of faults in a compact region of interest, we conclude that it is immaterial in what order spatial frames are assigned to isolate distinct sedimentary regions. In other words, the final subdivision is always the same no matter what the order of isolation is.

We think of mean curvature flow as an evolutionary process. For simplicity, we assume that any evolutionary process is a structure group of diffeomorphisms of some 4D fibre bundle. All information regarding the process at a moment in time is encoded in a time frame. A time frame contains a reference to a region of interest that in turn is represented as a 3D fibre bundle. We do not demand that an evolutionary process provide a physically plausible explanation of a formation state, rather it is enough if the visual expression appears plausible.

FIG. 40 illustrates a time-lapse seismic evolution (steam injection front tracking, with the left panel “before” and the right panel “after”.). We discuss now how we use spatial frames to define a topology graph. Let S be an implicit surface and let {Eₖ} be a family of elementary shapes that approximate S. Each Eₖ reduces its misfit with S by fitting a disjoint region of S to a telescopic extrusion of Eₖ.

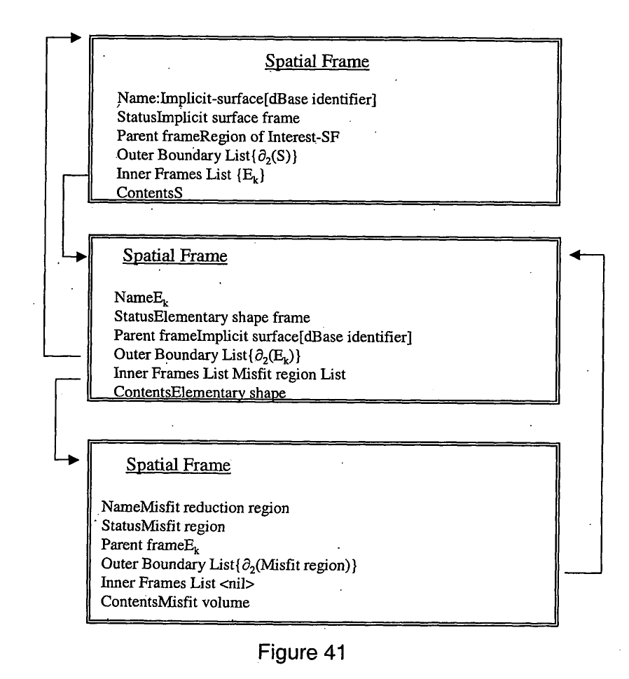

We use a different spatial frame to contain each telescopic extrusion and attach the collection of these frames. We assign each elementary shape to its own spatial frame and refer to the misfit reduction through attachment of the spatial frame list to the parent elementary shape frame. FIG. 41 shows the reference structure for this set of relationships.

We summarize the contents of the new class instances that we have defined in this paper.

Spatial Frame Class

1. Database identifier.
2. The parent spatial frame.
3. The list of children spatial frames.
4. A static hash table that provides the address of a spatial frame given a database identifier.
5. The outermost grid cell boundary, given as a pair of synchronized lists.
   a. The first list is a set of IJK base grid cells. The second list is in 1-1 correspondence with the first list.
   b. The second list is an ordered list of {left/right, up/down . . . } steps that define the grid cell face sequence that form the boundary.
6. The boundary curve contents of the grid cell boundary.
   a. Mandatory is a list of minima, maxima, and inflection points, ordered by arc length coordinate from the first critical point in this list.
   b. Optional is a list of conic sections that approximate the shape of the boundary restricted to each consecutive pair of critical points.
7. Transition zone, given as a grid cell thickness surrounding the interior of the outermost boundary. Zero thickness is acceptable.
8. The list of data base identifiers used to define the surfaces that intersect this spatial frame.
9. The data base identifier of the octree attached to this spatial frame.
10. Shape contents enclosed by the outer boundary. This can be void when the frame defines a hole.
11. Methods
   a. Put/GetNeighbor
   b. Put/GetLogicalNeighbor
   c. Put/GetShapeContents
   d. Put/GetSurfaceContents
   e. ReseampleSurface
   f. Put/GetOuterBoundary
   g. Put/GetInnerSpatialFrameList
   h. Put/GetParentSpatialFrame
   i. Put/GetTemporalFrame
12. Evolutionary law
   a. Parameter list
   b. Boundary conditions
   c. Initial conditions
   d. Status
      Shape Index Manifold
   1. Database identifier
   2. Status
   3. Floating point references
      a. XYZ
      b. ABC
   4. Misfit threshold
   5. Shape index charts
   6. Boundary representation node
      Shape Index Chart
   1. Database identifier
   2. Symmetry group isomorphism class
      {Sphere, Cylinder, Cone, Frustum, Torus, Ellipsoid, Hyperboloid_Type_I, Hyperboloid_Type_II, Circle, Ellipse, Cube, Tetrahedron, Square, Triangle, Rectangle, Cyclide, Trivial}
   3. Parameter vector ABC
   4. Canonical position transformation [Rotation matrix and translation vector]
   5. Shape index manifold
   6. Shape index interval
   7. Critical point list
   8. (Static) analytical methods
      a. Evaluator
      b. Normal
      c. Tangent
      d. First Fundamental Form
      e. Christoffel symbols
      f. Second Fundamental Form
      g. Gaussian curvature
      h. Mean curvature
      i. Principal curvature
      j. Shape index
      k. Signed distance function
      l. Closest point transform
      m. Parameter estimation
      n. Extrude
      o. Offset
      p. Adaptive sampling
   9. Standard methods
      a. Sve
      b. Restore
      c. I/O compress
      d. I/O decompress
      e. Delete
      f. Copy
      g. Newa
   10. Misfit reduction
      a. Absolute amount
      b. Relative amount
      c. Base type
         {Ellipse, Circle, Square, Triangle, Rectangle}
      d. Parameter vector list
         {u, v, normal offset}
            1D Boundary
   1. Conic section class
      {Ellipse, Circle, Line, Parabola, Hyperbola
   2. Plus side
   a. Shape index chart
   b. UV start stop
   3. Minus side
   a. Shape index chart
   b. UV start stop
   4. Boundary representation node
      Critical Point Assertion
      (We specify two lists, separating min/max from saddle point.)
   1. Shape index chart
   2. UV location
   3. Chart symmetry

We use Dustin Lister's trick of using a 2s complement 16-bit integer to subdivide length scale field data into (+/−) 32K increments. Given a reservoir model of size 9 square miles by 50000 feet, we can resolve data to 1 cm. Applying Dustin's idea to Shape index charts and dependent lists, we obtain a surprisingly compact data structure. For example, suppose that a shape index manifold contains 48 charts such that each chart supports 48 misfit reduction “boxes”. Further, suppose that each chart contains 4 critical point orbits relative to the chart symmetry group. Then the Shape Index manifold will consume on the order of 34000 bytes≈33 Kbytes of memory. These choices are arbitrary, but far exceed the empirically estimated values for the Top of Salt surface in the November 2002 Implicit Surface Proof of Concept data set. In that demonstration, this surface consumed slightly more than 1 MByte of memory, which implies that curvature-based methods are naturally 30 times more conservative in memory utilization.

Quadratic Taylor Expansion Disk Class

1. Status
   {CRITICAL_POINT_EXPANSION}
2. Expansion point
3. Principal curvatures
4. Rotation matrix and translation vector
5. Error tolerance
6. Shape index interval
7. Trimming curve discrete samples list
   Characteristic Length Scale Cone Class
1. Equivalence class
2. Status
3. Length scale
4. Top
   a. Radius
   b. Center
   c. Percent error
5. Bottom
   a. Radius
   b. Center
   c. Percent error
6. Slant height ratio

An example of applying the techniques described above to a relatively complicated surface will now be discussed. The example used herein is a synthetic surface designed to be an “unfriendly” test case. Approximately 14500 triangles were created from 7349 vertices. The representation requires approximately 1 Mb of memory.

Note that discrete estimators for Gaussian and mean curvature were used to compute the shape index. See, M. Desbrun, M. Meyer, P. Schroeder, A. Barr, Discrete Differential-Geometry Operators in nD, Technical Report Caltech, 2000. For example, the discrete estimator for mean curvature H*(P) evaluated at a point P is

$$H * ( P ) = \frac{1}{4 * area} {\sum }_{i} ( cot {α}_{i} - cot {β}_{i} ) \cdot ( P - {Q}_{i} )$$

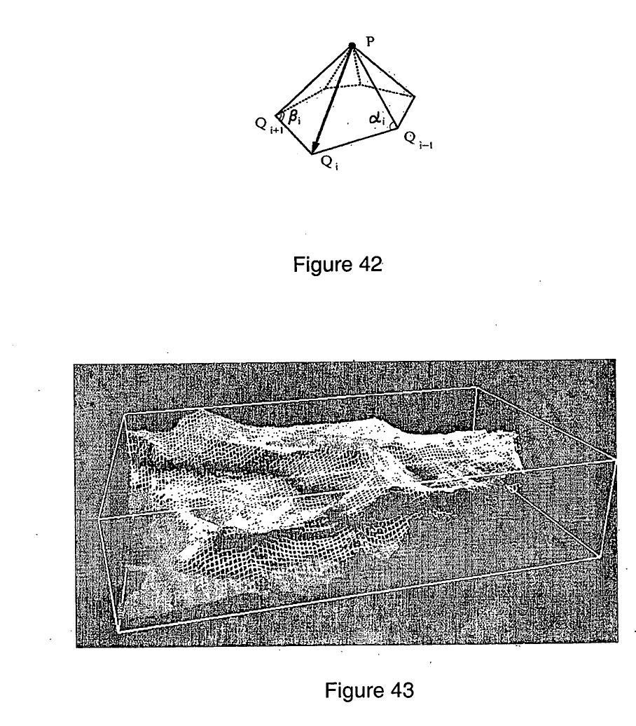

FIG. 42 is a schematic illustration of the definition of the variables in the mean curvature estimator. See, G. Stylianou, Comparison of triangulated surface smoothing algorithms, http://3dk.asu.edu/archives/seminars/presentation/Compsmthal.ppt.

The discrete Gaussian curvature estimator K*(P) evaluated at a point P is given by

$$K * ( P ) = 2 π - {\sum }_{i} {θ}_{i} ( P ) ,$$

where θᵢ is the i^{th} triangle's angle in the star of P rooted to P.

FIG. 43 is an image of the co-triangulated irregularly spaced mesh that represents the present example of the top of the salt.

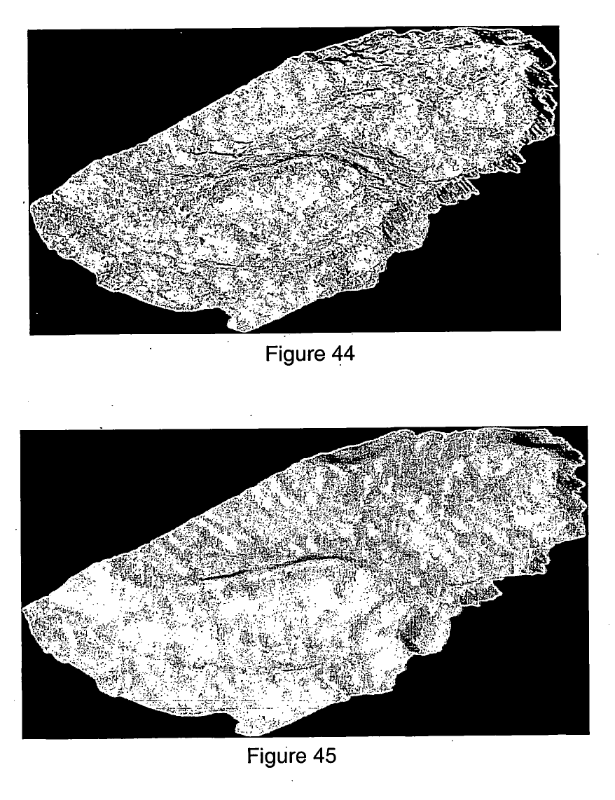

Several smoothing methods for triangulated surfaces have been considered, but all of them assume a regular spaced carrier grid. See, A. Hubeli, Multiresolution Techniques for Non-Manifolds, Diss ETH No. 14625, Computer Graphics Laboratory, Department of Computer Science, ETH Zurich, 2002. This surface is sampled irregularly, the mesh surface is re-samples by interpolating missing sample points. FIG. 44 shows the surface when re-sampled by interpolating missing sample points. The surface of FIG. 44 has approximately 10000 points versus 7900 points in the original mesh shown in FIG. 43.

The surface of FIG. 44 is noisy everywhere, but the noise is low amplitude. The preferred smoothing software according to A. Hubeli, Multiresolution Techniques for Non-Manifolds, Diss ETH No. 14625, Computer Graphics Laboratory, Department of Computer Science, ETH Zurich, 2002, incorporated herein by reference. The smoothing software moves points in the horizontal plane to minimize curvature, so it is necessary to project one version of the surface onto another when different numbers of iterations are applied

FIG. 45 shows the re-sampled surface after 25 iterations of smoothing. This surface is significantly smoother, but after comparing the two images we concluded that we have not sacrificed its intrinsic low frequency contents. The mean curvature flow preferentially removes high frequency noise and leaves intact low frequency intrinsic shape.

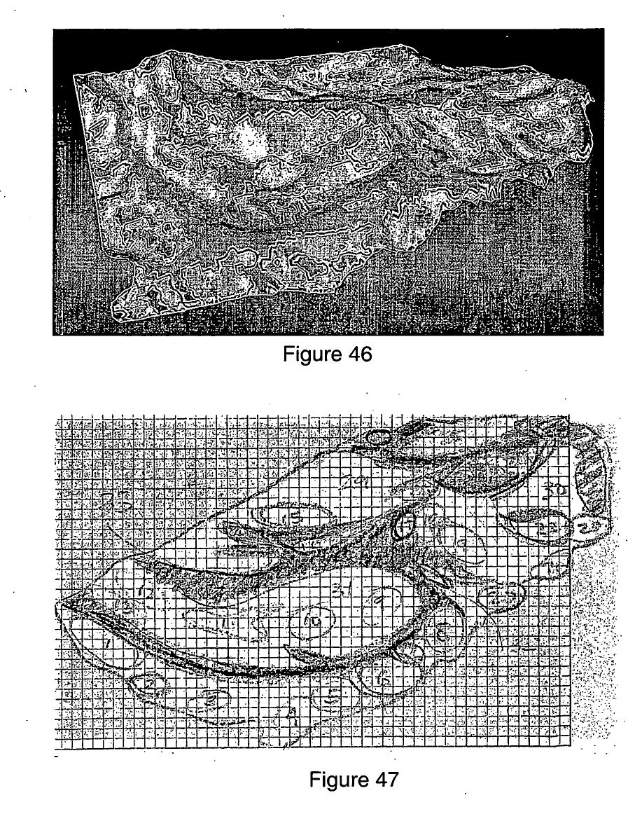

FIG. 46 shows the shape index map for the re-sampled triangulated surface after 25 iterations. There are regions of approximately the same shape index that contain islands that have significantly different shape index. An example of thins behavior is the red body in the bottom middle that contains two blue bodies.

We consider the following labeling options for this image. We recall that “label” is a grid cell equivalence class identifier.
1. Label each blue body and the surrounding red body as, separate shapes.
2. Label the two blue bodies as part of the same shape and consider the blue shape to be distinct from the enclosing red shape.
3. Label the red body as blue body misfits.
4. Label the blue bodies as red body misfits.

FIG. 47 shows that there are 33 shapes in the example. According to the data structure definition described above, about 512 bytes of storage are needed to express a shape with zero misfit reduction. Assuming adequate misfit reduction per shape consumes another 512 bytes, we conclude that we can well approximate this noisy surface in 33 Kbytes of data structure. We need about 1 Mbytes of storage to define this surface, so we obtain a 1000/33=30-fold compression.

It is important to understand that we do not equate a geometrical label to a geological theory. We prefer a description of the topography that uses the least number of parameters.

According to preferred embodiments of the invention an important implicit surface data structure is the narrow band octree. The curvature analytical enhancements to implicit surface technology described herein enable the construction a reservoir framework using significantly less memory and CPU than conventional triangulated surface technology requires. Additionally, the curvature-based methods describe herein enable the construction of a new generation of structural framework. We enumerate a number of advantages of curvature analysis in support of implicit surface methods, according to preferred embodiments of the present invention.

I. Computer Resource Economy

a. We describe the shape of a geological surface in terms of explicit surface forms, e.g., ellipsoid and torus, rather than contextually in terms of a technology used to represent shape, e.g., triangles.
b. We replace numerical computation of curvature, normals, signed distance functions, etc. by analytical formulae which enables us to drop the buffering needed to hold the sampled data.
   II. Surface Flattening
c. Many operations on surfaces are easier to perform when a flattened version of a surface is available.
d. We refer to the flattening as the “parameterization” of the surface.
e. When we construct the parameterization of a surface, then we also generate an estimate of the geometric strain needed to flatten the surface. Strain says how comparable is the flattened version to the given surface.
f. Parameterization is much more useful if the flattened surface can be placed in the framework, rather than on some planar surface that is outside the framework. Shape analysis enables us to embed the parameter space surface in our xyz coordinate space.
   III. 3D Conformal Grid Generation and Forensic Reconstruction
g. Using surface parameterisation, shape analysis knows how extract a 3D conformal grid from each framework sub-volume.
h. Regular grids are convenient for simulation. That does not mean that we have to permanently record a regular sampling in regions that show little or no variation. We equate this variation to an estimate of curvature. On demand we provide regularly spaced samples in low curvature regions.
i. We call this curvature-adaptive sampling. Curvature adaptive sampling does not waste space on recording redundant information.
j. Curvature-dependent adaptive grid generation is more economical than the non-curvature-adaptive form. An application can easily extract a perfectly uniform 3D grid on demand.
k. Mean curvature flow can be used to fill in holes and to construct a plausible representation of an eroded region of a sequence.
   IV. Framework Construction, Editing, and Reconstruction
l. Based on the implicit surface's signed distance function, we construct a connected sum of shapes that are sectors of a conic section fibre bundle.
m. Boolean operations that take shape into account are more efficient than those that do not.
n. Sending and receiving elementary shape descriptions is inherently more efficient than sending and receiving the corresponding triangulation. The Marching Cubes algorithm can be used to triangulate an implicit surface's elementary shape constituents.
o. The identification of elementary shapes is based on application of mean curvature flow (mcf).
p. We do not worry if a process is well approximated by mcf. Rather all that matters is whether the elements in a framework can be defined as the solution to a flow problem.
q. We use structure synopsis diagrams to send and receive a high level resume of the connectivity and shape of a structural framework. This data structure extends the traditional Reeb graph summary of connectivity to a shape description that is intuitive—which is something a byte stream describing millions of triangles can never hope to achieve.
   V. Noise Suppression
r. Elementary shape identification can be applied to a noisy surface.
s. Shape analysis provides a tool to distinguish noise suppression from shape decay.
   VI. Robust Shape Identification
t. Suppose that an implicit surface is represented in a 3D grid with a tri-linear interpolation function. We have discovered necessary conditions on the interpolation function coefficients in order that a grid cell in the grid contain a critical point. It is very easy and fast to test these conditions, so we can quickly locate a surface's critical points in the grid.
u. Group theory yields a robust classification of symmetry induced from the tri-linear interpolation approximation of the implicit surface's signed distance function. This is used to identify the optimal elementary shape candidate shape that fits a single grid cell of the 3D grid representation of the implicit surface.
v. It enables local quantitative comparison of two surface shapes. The process identifies regions on the measured surface where there is poor agreement and provides an estimate of the energy expended in the geometrical transformation needed to finish the package.

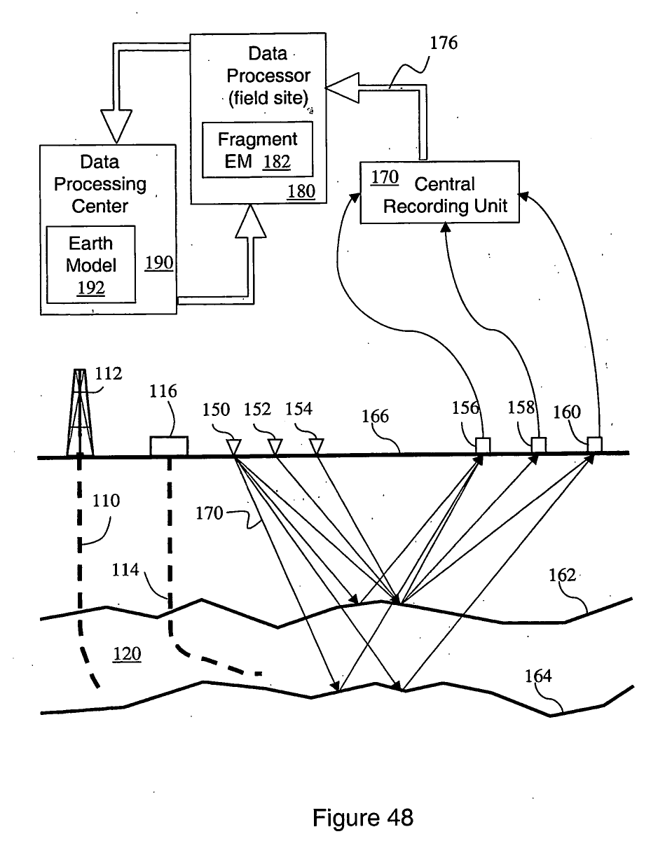

FIG. 48 is a schematic illustration of a system for improved extraction of hydrocarbons from the earth, according a preferred embodiment of the invention. Seismic sources 150, 152, and 154 are depicted which impart vibrations into the earth at its surface 166. The vibrations imparted onto the surface 166 travel through the earth; this is schematically depicted in FIG. 7 as arrows 170. The vibrations reflect off of certain subterranean surfaces, here depicted as surface 162 and surface 164, and eventually reach and are detected by receivers 156, 158, and 151.

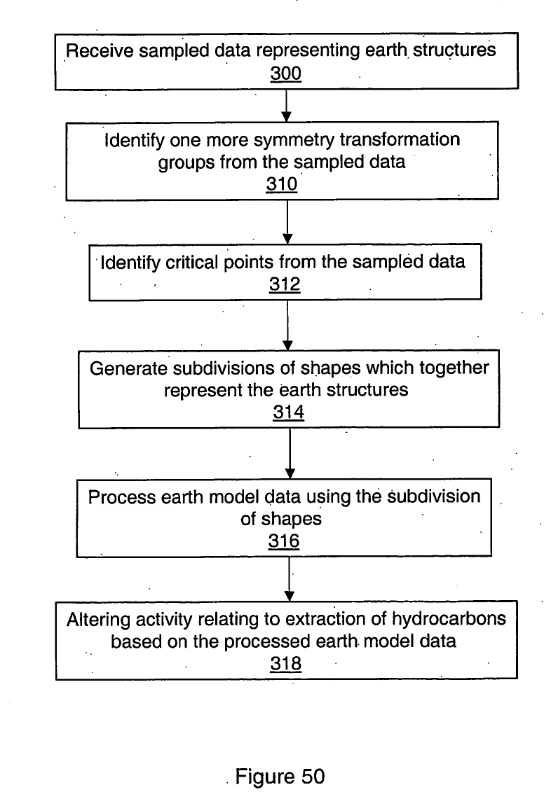

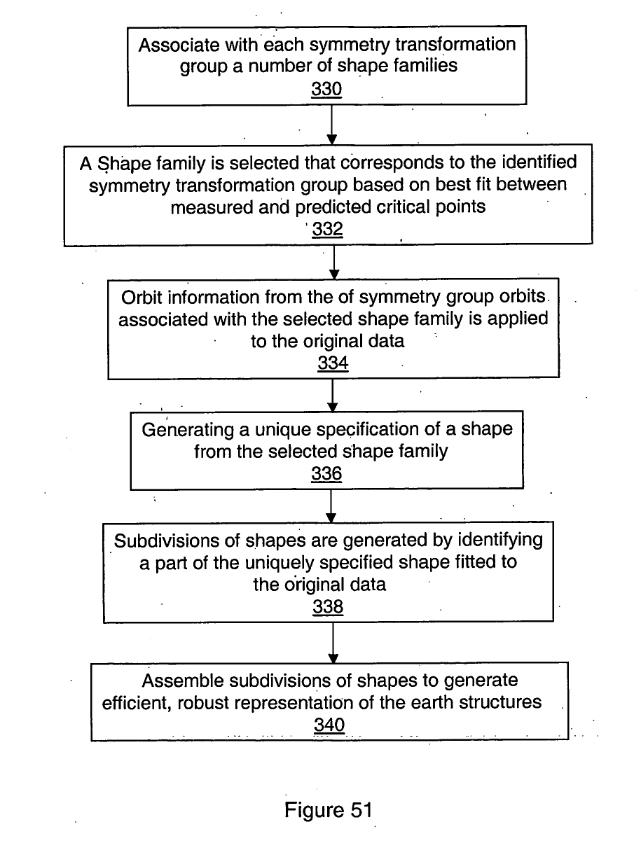

Each of the receivers 156, 158, and 151 convert the vibrations into electrical signals and transmit these signals to a central recording unit 170, usually located at the local field site. The central recording unit 170 typically has data processing capability such that it can perform a cross-correlation with the source signal thereby producing a signal having the recorded vibrations compressed into relatively narrow wavelets or pulses. In addition, central recording units may provide other processing which may be desirable for a particular application. Once the central processing unit 170 performs the correlation and other desired processing, it communicates the seismic data to data processor 180 which is typically located at the local field site. The data transfer from the central recording unit 170 in FIG. 7 is depicted as arrow 176 to a data processor 180. Data processor 180 can be used to perform processing as described in steps 300 to 316 in FIGS. 50 and 330 to 340 in FIG. 51, as is described more fully below.

The seismic data collected from recording unit 170 which is usually a relatively large data set. Importantly, according to the invention, the data processing to generate an efficient and robust subdivision of shapes representing the seismic data is performed on data processor 180. In this way a compressed, stable, accurate representation of new data is transmitted to other processing centers.

At the field site, a subset 182 of a larger earth model 192 is provided to aid in the field activities. The after the subdivision of shapes, the Fragment earth model 182 can be updated with the newly acquired data for use locally.

Data processing center 190 is located away from the wellsite or field site, typically at an asset management location. In some cases data processing center 190 is physically distributed across a number of separate processing centers over a wide geographic region. Data processing center 190 integrates the subdivision of shapes representing the earth structures into existing earth model 192. The integration of both the geometry framework and material field properties is preformed. While in some cases the integration of the new shape information can be done at the field site, this is not normally done due to a number of factors including (1) lack of full data set of earth model at the field site, lack of computational facilities, and lack of sufficient local expertise.

Once the earth model 192 is updated with the newly acquired information, updated earth model data from model 192 is preferably sent back to the field site data processor 180. The information sent back to the field site preferably includes both (1) shape information to update geometry framework and material field properties of earth model fragment 182, and (2) decisions relevant to field site activities based in part on the updated earth model 192.

For example, according to one embodiment, based on new information integrated in earth model 192 at data processing center 190, improved predictions of fluid flow are made though the earth structures. Based on these improved predictions the rate of extraction from production well 114 is preferably altered using surface equipment 116 to optimize production rates from reservoir rock 120 while minimizing likelihood of undesirable events such as water breakthrough.

According to an embodiment during the wellbore construction, based on new information integrated in earth model 192 at data processing center 190, improved predictions on the likelihood of structural failure of a wellbore 110 being drilled into reservoir rock 120 from drilling rig 112. Based on these improved predictions, the drilling plan used to drill the well 110 is preferably updated, for example to reduce the risk of wellbore stability problems, to steer the drilling activity more precisely to certain locations within the reservoir rock and/or avoid faults, etc.

According to another embodiment of the invention, data processing center 190 can more easily communicate geologic information from one earth model based on geometrical representation to another earth model based on a different geometrical representation. In this way, the invention can be used to facilitate communication of earth model information between different models. Similarly, according to another embodiment of the invention, the techniques described her used to facilitate the aggregation of geologic information from a number of geometrical representations of the earth structures.

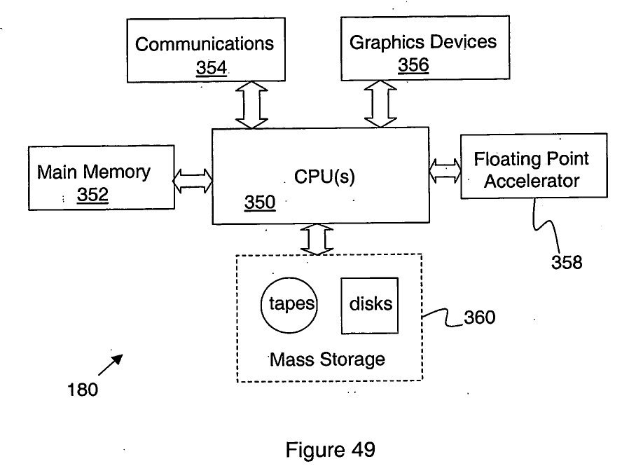

FIG. 49 shows further detail of data processor 180, according to preferred embodiments of the invention. Data processor 180 preferably consists of one or more central processing units 350, main memory 352, communications or I/O modules 354, graphics devices 356, a floating point accelerator 358, and mass storage such as tapes and discs 351.

FIG. 50 shows steps in a method for processing data used for hydrocarbon extraction from the earth, according to preferred embodiments of the invention. In step 300, sampled data representing earth structures is received. In step 310 one more symmetry transformation groups are identified from the sampled data. In step 312, a set of Morse theoretical height field critical points are identified from the sampled data. In step 314, a plurality of subdivisions of shapes are generated such that when aggregated, the subdivisions accurately, efficiently, and robustly represent the original earth structures. The generation in step 314 is based on the set of identified critical points and the symmetry transformation groups, according to the techniques descried above and in further detail in FIG. 51. In Step 316, earth model data is processed using the generated subdivision of shapes. In step 318 activity relating to extraction of hydrocarbons from a hydrocarbon reservoir is altered based on the processed earth model data. Various embodiments involving processing of earth model data and altering activity in steps 316 and 318 are described above with respect to FIG. 48.

FIG. 51 shows further detail of steps in generating an efficient and robust subdivision of shapes, according to preferred embodiments of the invention. In step 330, each of the identified symmetry transformation groups is preferably associated with to a plurality of shape families. Each of the shape families preferably includes a set of predicted critical points. The shape families for each symmetry transformation group are preferably contained in a lookup table. In step 332 a shape family is selected from the plurality of shape families. The selection is preferably based on closeness of correspondence, or best fit, between the identified critical points from the original sampled data and the predicted critical points of the selected shape family.

Note that each of the symmetry transformation groups is preferably a set of diffeomorphisms that act on a topologically closed and bounded region in space-time such that under transformation the region occupies the same points in space.

Each shape family preferably has an associated set of symmetry transformation group orbits, each orbit being associated with orbit information that specifies whether the orbit contains a predicted critical point and value of the Gaussian curvature of a point in the orbit. In step 334, the orbit information from the set of symmetry transformation group orbits associated with the selected shape family is preferably applied to the original sampled data. In step 336 the result of step 334 yields a unique specification of a shape from the selected shape family. In step 338, each of the plurality of subdivisions of shapes is preferably generated by identifying a part of the uniquely specified shape that corresponds to the sampled data. In step 340, the identified parts are assembled, or sewn together, such that a representation of the earth structures is generated.

The assembled subdivisions are advantageously more efficient and robust than conventional methods. For example the number of parameters in each subdivision times the number of subdivisions is substantially-less then would be needed using a faceted representation method, and the plurality of subdivisions is more numerically stable than third order or higher representation.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. A method for processing data used for hydrocarbon extraction from the earth comprising the steps of:
receiving sampled data representing earth structures;
identifying one or more symmetry transformation groups from the sampled data;
identifying a set of critical points from the sampled data;
generating a plurality of subdivisions of shapes the subdivisions together representing the earth structures, the generation being based at least in part on the set of identified critical points and the symmetry transformation groups; and
processing earth model data using the generated subdivision of shapes.

2. A method according to claim 1 wherein the identified symmetry transformation group is a set of diffeomorphisms that act on a topologically closed and bounded region in space-time such that under transformation said region occupies the same points in space.

3. A method according to claim 1 wherein each of the identified symmetry transformation groups corresponds to a plurality of shape families.

4. A method according to claim 3 wherein each of the plurality of shape families comprises a set of predicted critical points.

5. A method according to claim 4 wherein the step of generating subdivisions comprises selecting a shape family from the plurality of shape families that corresponds to the identified symmetry transformation group, said selecting being based on closeness of correspondence between the identified critical points from the sampled data and the predicted critical points of the selected shape family.

6. A method according to claim 5 wherein each shape family has an associated set of symmetry transformation group orbits, some of the orbits being associated with critical points and other orbits being associated with distinguished Gaussian curvature values.

7. A method according to claim 6 wherein each symmetry transformation group orbit of the selected shape family is associated with orbit information that specifies whether the orbit contains a predicted critical point and value of the Gaussian curvature of a point in the orbit.

8. A method according to claim 7 wherein the orbit information from the set of symmetry transformation group orbits associated with the selected shape family is applied to the sampled data thereby generating a unique specification of a shape from the selected shape family.

9. A method according to claim 8 wherein each of the plurality of subdivisions of shapes is generated by identifying a part of the uniquely specified shape that corresponds to the sampled data.

10. A method according to claim 9 wherein the identified parts of the uniquely specified shapes are assembled, thereby generating a representation of the earth structures.

11. A method according to claim 10 wherein the generated representation is continuous.

12. A method according to claim 11 wherein the generated representation is smooth.

13. A method according to claim 9 wherein the uniquely specified shapes are specified using differentiable functions including one or more of the following types: surfaces derived from conic sections, splines, general polynomials and trigonometric functions.

14. A method according to claim 1 wherein the sampled data is smoothed prior to said steps of identifying critical points and identifying one or more symmetry transformation groups.

15. A method according to claim 1 wherein the identified critical points are Morse theoretical height field critical points consisting of the following three types: minima, maxima and saddle points.

16. A method according to claim 15 wherein said step of generating a plurality of subdivisions comprises applying a canonical homogeneous transform such that the number of parameters needed to uniquely describe a shape in the earth structure is minimized.

17. A method according to claim 1 wherein the earth model data is geologic data, geophysical data, petrophysical data, mechanical earth model data and/or reservoir fluid flow data.

18. A method according to claim 1 wherein earth model data is processed such that earth models are updated, alternative versions of existing earth models are created, time-lapse earth models are generated and/or the earth model data is distributed to other earth models or other applications.

19. A method according to claim 1 wherein the sampled data represents sampled physical structure and material properties of the earth structures.

20. A method according to claim 1 wherein said step of processing earth model data comprises making predictions of fluid flow though at least some of the earth structures and wherein the altered activity is altering the rate of extraction based on said predictions.

21. A method according to claim 1 wherein said step of processing earth model data comprises predicting the likelihood of structural failure of a wellbore though at least some of the earth structures and wherein the altered activity is altering the drilling of the wellbore based on the predicted likelihood of failure.

22. A method according to claim 1 wherein said step of processing earth model data comprises communicating geologic information relating to at least some of the earth structures between a first geometrical representation and a second geometrical representation of the earth structures.

23. A method according to claim 1 wherein said step of processing earth model data comprises aggregating information from a plurality of geometrical representations of the earth structures and wherein the altered activity is based at least in part on the aggregated information.

24. A method according to claim 1 wherein said step of processing earth model data comprises constructing an earth model to a user specified error tolerance using the generated subdivision of shapes.

25. A method according to claim 1 wherein each of the plurality of subdivisions of shapes is generated by identifying a part of a uniquely specified shape that corresponds to the sampled data.

26. A method according to claim 1 wherein the step of generating a plurality of subdivisions comprises the steps of:
analyzing curvature of the sampled data thereby generating a shape index field; and
identifying functions that fit the shape index field.

27. A method according to claim 26 wherein the functions are differentiable.

28. A method according to claim 1 wherein the plurality of subdivisions are generated such that the number of parameters in each subdivision times the number of subdivisions is substantially less than would be needed using a faceted representation method.

29. A method according to claim 1 wherein the plurality of subdivisions are generated such that they are more numerically stable than third order or higher representation.

30. A method according to claim 1 wherein the sampled data is a faceted representation of the earth structures.

31. A method according to claim 30 wherein the faceted representation is a triangle mesh.

32. A method according to claim 30 wherein the faceted representation is a grid.

33. A method according to claim 1 wherein the sampled data is data measured with seismic acquisition equipment.

34. A method according to claim 33 wherein said steps of receiving, identifying one or more symmetry transformation groups, identifying a set of critical points and generating a plurality of subdivisions of shapes are preformed at or near the location where the sample data is measured.

35. A method according to claim 34 wherein said step of processing earth model data is performed in one or more locations remote from the location where the sample data is measured.

36. A system for improved extraction of hydrocarbons from the earth comprising:
a storage system adapted to receive and store sampled data representing earth structures;
a processing system adapted to identify one or more symmetry transformation groups from the sampled data, identify a set of critical points from the sampled data, and generate a plurality of subdivisions of shapes the subdivisions together representing the earth structures, the generation being based at least in part on the set of identified critical points and the symmetry transformation groups;
an earth model processing system adapted to processes earth model data using said generated subdivision of shapes; and
an interface to output the processed earth model data to an operator.

37. A system according to claim 36 wherein the identified symmetry transformation group is a set of diffeomorphisms that act on a topologically closed and bounded region in space-time such that under transformation said region occupies the same points in space.

38. A system according to claim 36 wherein each of the identified symmetry transformation groups corresponds to a plurality of shape families, each of which comprises a set of predicted critical points.

39. A system according to claim 38 wherein the subdivisions are generated such that a shape family is selected from the plurality of shape families that corresponds to the identified symmetry transformation group, said selecting being based on closeness of correspondence between the identified critical points from the sampled data and the predicted critical points of the selected shape family.

40. A system according to claim 39 wherein each shape family has an associated set of symmetry transformation group orbits, each orbit being associated with orbit information that specifies whether the orbit contains a predicted critical point and value of the Gaussian curvature of a point in the orbit, and wherein the orbit information from the set of symmetry transformation group orbits associated with the selected shape family is applied to the sampled data thereby generating a unique specification of a shape from the selected shape family.

41. A system according to claim 40 wherein each of the plurality of subdivisions of shapes is generated by identifying a part of the uniquely specified shape that corresponds to the sampled data, and wherein the identified parts are assembled, thereby generating a representation of the earth structures.

42. A system according to claim 36 as part of a system adapted to assist a decision making process relating to extraction of hydrocarbons from a hydrocarbon reservoir modeled by the processed earth model data.

43. A system according to claim 36 wherein the plurality of subdivisions are generated such that they are more numerically stable than third order or higher representation.

44. A system according to claim 36 wherein the sample data are acquired from the earth structures using seismic acquisition equipment, the storage system and the processing system are located at or near the location where the sample data are acquired, and the earth model processing system is located in one or more locations remote from the location where the sample data is acquired.
